(19) United States
(12) Patent Application Publication
(10) Pub. No.: US 2017/0083817 A1
(43) Pub. Date: Mar. 23, 2017

(54) TOPIC DETECTION IN A SOCIAL MEDIA SENTIMENT EXTRACTION SYSTEM

(71) Applicant: ISENTIUM, LLC, Miami Beach, FL (US)

(72) Inventors: Anna Maria Di Sciullo, Montreal (CA); Gautham Sastri, Miami Beach, FL (US)

(21) Appl. No.: 15/272,678

(22) Filed: Sep. 22, 2016

Related U.S. Application Data
(60) Provisional application No. 62/222,404, filed on Sep. 23, 2015.

(51) Int. Cl. G06N 5/02; G06F 17/27; G06N 5/04

(52) U.S. Cl. CPC G06N 5/025; G06N 5/048; G06F 17/277

(57) ABSTRACT

A computer-implemented system for real time topic detection in a social media message includes a knowledge base of keywords used to ingest the social media message and a partial parser deriving a syntax-semantic parse tree. The system also includes a topic calculator compositionally deriving the topic of the social media message by computing a topic value for given entities in the event described by the social media message. The topic value is derived from a first set of rules assigning Restrictor R-value to prominent R-expressions compositionally in the syntax-semantic parse tree and a second set of rules assigning a numeric Strength S-value to the R-expressions according to whether or not they are part of anaphoric chains in the social media message, and whether or not the R-expressions include name entities that are part of the knowledge base of keywords.

### CROSS REFERENCE TO RELATED APPLICATION

This application claims the benefit of U.S. Patent Application Ser. No. 62/222,404, entitled “TOPIC DETECTION IN A SOCIAL MEDIA SENTIMENT EXTRACTION SYSTEM,” filed Sep. 23, 2015.

### BACKGROUND OF THE INVENTION

1. Field of the Invention

The invention relates to information extraction and, in particular, topic detection.

2. Description of the Related Art

Current topic detection systems rely on two basic techniques: i) statistical techniques, including machine learning (e.g., Huang, F.; Xiao, N.; Cheng, X and Xiao, R., “An Approach to mining Social Networks in Chat Rooms,” Journal of Computational Information Systems, Vol. 7:1, (2011): pp. 135-143 (Huang et al)) and ii) Natural Language Processing (NLP) techniques, including part of speech (POS) tagging (e.g., Wang, G.; Shang, Z.; Sun, J.; Yang, S. and Larson, C., “POS-RS: A Random Subspace method for sentiment classification based on part-of-speech analysis,” Information Processing & Management, (October 2014): DOI: 10.1016/j.ipm.2014.09.004 (Wang et al.)) and the use of lexical semantics nets (e.g., Liu, Z.: Yu, W.; Chen, W.; Wang, S. and Wu, F., “Short Text Feature Selection for Micro-Blog Mining,” Conference: Computational Intelligence and Software Engineering (CiSE), 2010 International Conference on Source: IEEE Xplore (Liu et al.)). However, purely statistical methods and POS methods for topic detection do not give optimal results. Their main pitfall is that they do not detect topics in their syntax-semantic asymmetrical contexts. Furthermore, they do not detect the topic in specific domains of interpretation including world knowledge.

The statistical approaches attempt to identify topics based on the occurrence frequencies of various words or sets of words in documents. Applying this approach to different learning methods, supervised or unsupervised learning techniques, can be used in the classification process. For example, in Quinding, S.; Qian, W. and Hongli, Q., “The Algorithm of Short Message Hot Topic Detection Based on Feature Association,” Information Technology journal, Vol. 8, (2009): pp. 236-240 (Quinding et al.), feature association analysis and statistical regularities are used for topic detection in short social media messages. Feature words in short social media messages are clustered into different word bags by calculating the association degree of these feature words. Topics can be identified by mean s of word bag matching.

Feature selection is also a technique used in current topic detection systems. This technique extracts a number of feature subsets, which are the most representative of the original meaning. However, existing feature selection methods cannot effectively extract these short text features, which greatly reduce the classification and clustering performance on short text. In this regard, Liu et al. proposes a selection method based on POS and HowNet. As those skilled in the art will appreciate, HowNet is an on-line knowledge base unveiling inter-conceptual relations and inter-attribute relations of concepts. According to the composition of the text property, the words with larger amounts of information by different POS are chosen and then the semantic features of these words are expanded based on HowNet. This ensures that the short documents have more useful features. Wang et al. also indicates that part of speech has the potential of being successfully applied to text classification problems. Yet, other works, including Huang et al., suggest integrating dialog thread structure association with message content similarity. This may lead to improve traditional vector space models with semantic similarity of terms. However, this is not a viable solution for online processing of short messages ingested on the basis of keywords.

The performance of current topic detection systems is not optimal. NLP approaches rely on text segmentation, n-grams, POS and lexical semantic information without taking into consideration the position of the parts of speech in their syntactic configuration. However, in several languages, including English, the position of a given POS in its syntax-semantic structure indicates whether it is a topic or a comment. As will be appreciated based upon the following disclosure, the present invention overcomes this shortcoming by operating under the premise that the recovery of the asymmetrical topic-comment relation in short messages optimizes the performance of topic detection.

The statistical method, such as the clustering keywords method, fails to properly identify topics because it applies to occurrence frequency of words in documents regardless of their syntax-semantic context. Likewise, the noun-phrase extraction method fails because the constituents are extracted without taking into consideration their position in the syntax-semantic contexts. It is not the case that any constituent in a sentence qualifies as a topic, only certain referential expressions (hereafter R-expressions) in certain syntax-semantic configurations qualify as a topic. Furthermore, it is not the case that the most frequent expressions in a text constitute the topic of that text because an expression may qualify as a comment rather than a topic in a document.

Companies, such as Alphasense, use the traditional statistical approach and POS approaches to topic detection. For example, Alphasense “categorizes each line of text into semantic search index” without taking into account the asymmetry of the topic-comment information structure. Consequently, information that is part of comments can be detected instead of the information pertaining to topics. This is also the case for Attensity, that analyses multi-channel customer conversations and Satasift that analyses trends and topics from Facebook. Contrary to the present invention, the products of these companies do not rely on the asymmetrical property of topics. In particular, they do not detect topics on the basis of the prominence of R-expressions in syntax-semantic parse trees or of the knowledge bases of keywords.

With the foregoing in mind, it is appreciated that a topic detection system sensitive to the syntax-semantic configurations as well as to world knowledge is needed. The present invention relates to a universal method and system for real-time event driven topic detection in short social media messages based on natural language syntax-semantic asymmetries and domains of interpretation. The system is universal, and thus it can be parameterized to different domains of interpretation, including finance, politics and tourism.

### SUMMARY OF THE INVENTION

It is, therefore, an object of the present invention to provide a computer-implemented system for real time topic detection in a social media message, wherein information structure of the social media message includes a topic and a comment, and wherein the topic is an R-expression (Referential expression) that restricts the information structure of an event described by the social media message. The system includes a knowledge base of keywords used to ingest the social media message and a partial parser deriving a syntax-semantic parse tree. The system also includes a topic calculator compositionally deriving the topic of the social media message by computing a topic value for given entities in the event described by the social media message. The topic value is derived from a first set of rules assigning a numeric value to prominent R-expressions compositionally in the syntax-semantic parse tree and a second set of rules assigning a numeric value to the R-expressions according to whether or not they are part of anaphoric chains in the social media message, and whether or not the R-expressions include name entities that are part of the knowledge base of keywords.

It is also an object of the present invention to provide a computer-implemented system for real time topic detection in a social media message including an inference engine reducing uncertainty in results of the topic calculator.

It is another object of the present invention to provide a computer-implemented system for real time topic detection in a social media message wherein the inference engine includes a data structure and a set of inference rules.

It is a further object of the present invention to provide a computer-implemented system for real time topic detection in a social media message wherein the topic value of the social media message is associated with a strength value 1 to 3, where 1 is the lowest strength and 3 is the highest strength.

It is also an object of the present invention to provide a computer-implemented system for real time topic detection in a social media message wherein the strength value is the sum of the numeric Strength S-value of the second set of rules.

Other objects and advantages of the present invention will become apparent from the following detailed description when viewed in conjunction with the accompanying drawings, which set forth certain embodiments of the invention.

### BRIEF DESCRIPTION OF THE DRAWINGS

FIG. 1 is a schematic overview of the present system.

FIG. 2 is a representation of the graphical user interface in accordance with the present invention.

FIG. 3 is a partial view of the reaction indicator.

FIG. 4 is a graphical depiction showing the correlation of frequency and sentiment.

FIG. 5 is a screen shot showing the ingesting and processing of various assets.

FIGS. 6A and 6B are screen shots when a moving spherical graphic object is clicked in the graphical user interface.

FIG. 7 is a screen shot showing various moving spherical graphic objects shrinking and growing based on social media intensity thereof.

FIG. 8 shows the structure of a stock asset tree and a competition map in accordance with the present invention.

FIG. 9 is an asset tree and a competition map for AAPL in accordance with the present invention.

FIG. 10 is the structure of a political asset tree and a competition map in accordance with the present invention.

FIG. 11 is a political asset tree and a competition map related to the 2016 United States presidential election in accordance with the present invention.

FIG. 12 is the structure of the city asset tree and a competition map in accordance with the present invention.

FIG. 13 is a city asset tree and a competition map related to the World Expo 2020 in accordance with the present invention.

### DESCRIPTION OF THE PREFERRED EMBODIMENT

The detailed embodiment of the present invention is disclosed herein. It should be understood, however, that the disclosed embodiment is merely exemplary of the invention, which may be embodied in various forms. Therefore, the details disclosed herein are not to be interpreted as limiting, but merely as a basis for teaching one skilled in the art how to make and/or use the invention.

The present invention provides a computer-implemented method and system for real time topic detection in short messages generated by social media. The method and system employ a topic calculator that identifies topics on the basis of a set of rules deriving the saliency and strength of R-expressions in their syntax-semantic asymmetrical structure and with respect to their domain of interpretation. The topic calculator is part of an event driven information extraction system as disclosed in U.S. Patent Application Publication No. 2012/0246104, entitled “Sentiment Calculus For A Method And System Using Social Media For Event-Driven Trading,” ('104 publication) which to the extent relevant, is incorporated herein by reference.

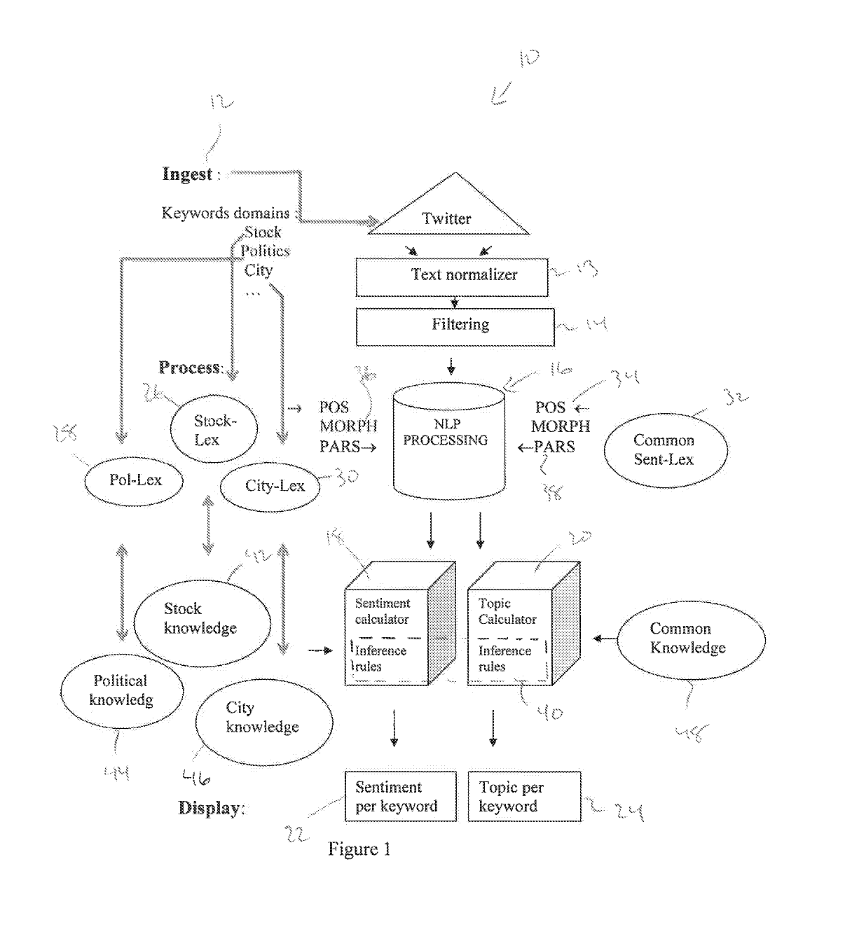

Briefly, and as will be appreciated based upon the following disclosure, the topic calculator of the present system may be thought of as one module of a multi-layered pipeline that acts upon social media messages to gather desired information. The topic calculator applies topic calculus to the incoming short messages, such as social media messages, and yields a topic-per-keyword for each ingested message in real-time. The topic calculator proceeds in parallel with the sentiment calculator of the event driven information extraction system of the '104 publication. The sentiment calculator calculates the sentiment-per-keyword for each incoming message ingested by the event driven information extraction system. FIG. 1 shows the three main components of the event driven information extraction system: Ingest, Process, and Display. It also identifies the specific NLP processor processing the social media messages from the ingest, component, to the topic calculator and the sentiment calculator and their interaction with the inference engine. FIG. 1 also illustrates that the generic system can be parameterized to apply to different domains of interpretations, including finance, politics and cities. To this effect, the sentiment extraction system of the present invention includes, in addition to a common lexicon and a common knowledge of the world, domain specific lexicons as well as a domain specific knowledge bases.

Thus, the core architecture of the sentiment extraction system is universal, in the sense that it can be used for topic detection and sentiment mining of textual information. Moreover, it can be parameterized to apply to any specific language, given the setting of language specific parameters, as well as to specific domains of interpretation given specialized lexicons and knowledge bases.

As will be explained below in detail, the topic calculator in accordance with the present invention uses social media messages for real-time identification of what the social media messages are about. The topic calculator identifies the expressions referring to this information as well as assigns a prominence value to the expressions referring to this information. The topic calculator is sensitive to the syntax-semantic prominence of the referential expressions in the sentences constituting the social media messages as well as to their relatedness to the name entities populating the knowledge base of the keywords used to ingest the social media messages. The name entities are automatically recognized by the system in the early stage of the processing, and thus they are available for topic identification in the syntax-semantic parse trees of the messages.

The topic calculator uses a rule-based method and a system for real-time processing of what short social media messages are about. The rule-based method and system considers the syntax-semantic structure of the sentences constitutive of short social media messages and calculates the topic value of the referential expressions (R-expressions) in these short social media messages. The system assigns topic values to R-expressions according to their syntax-semantic prominence and their relation to the knowledge base of keywords used to ingest the social media messages.

With this in mind, the present method and system provide for real-time detection of the topics of short messages generated through social media on the basis of pre-specified keywords in conjunction with sentiment information generated by way of the event driven information extraction system of the '104 publication.

As briefly discussed above, and with reference to FIG. 1, the topic calculus is integrated in a pipeline that derives the sentiment of incoming social media messages for the real-time evaluation of public assets (see the '104 publication). Both the topic calculus and the sentiment calculus apply to the syntax-semantic parse tree of incoming social media messages, and derive sentiment values and topic values for designated expressions in these social media messages. The derived sentiment values and topic values are combined to render combined topic-sentiment values that provide valuable data points to gain real-world insights to promote informed behaviors in finance, as well as in other areas, such as politics, health, security or tourism, and to provide structured indicators of trends.

As will be fully appreciated based upon the following disclosure, the system 10 includes an ingest component 12 for ingesting the social media messages; a filter module 14 eliminating expressions not considered useful language from social media messages; an NLP processor 16 processing filtered social media messages; a sentiment calculator 18 applying rules to the filtered and NLP processed social media messages so as to compute a representation of values associated with the filtered and NLP processed social media messages; a topic calculator 20 identifying topics on the basis of a set of rules deriving the saliency and strength of R-expressions in their syntax-semantic asymmetrical structure and with respect to the knowledge base of the keywords used to ingest the messages; and a graphical user interfaces 22, 24 displaying the values generated by the sentiment calculator 18 and the topic calculator 20.

It is appreciated that information structure consists of two parts: the topic, representing familiar information, and the comment, updating the context, (1).
(1) Information structure: (topic, comment)

Textual topic-comment information structure is encapsulated in sentences. The topic of a sentence is what the sentence is about and it represents the old information. The comment is what is said about the topic and it represents new information. The topicalized part of a sentence is the restrictor of the information structure (the topic, the familiar information). The remaining part of the sentence is the nuclear scope (the comment, updating the old information or context). In the representation in (2), the predicate Pred1 is the restrictor and the predicate Pred2 is the nuclear scope. The nuclear scope updates or adds information to the context given by the former (plus the preceding context). For example, the topic of the simple active sentence in (3) is ipad sales, and the comment is the remaining part of the sentence, as represented in (4). The topic of (5) is Hillary Clinton, and the comment is the remaining assertion of the sentence, as represented in (6). See also (7) and (8).
(2) TOP(x)|(Pred1(x), Pred2(x))
(3) $AAPL. ipad sales are cratering http://stks.co/t1iBt
(4) TOP(ipad sales)|(Pred1 (ipad sales), Pred2 (are cratering))
(5) “@washingtonpost: Hillary Clinton at rally: “I'm not running for someAmericans, but for all Americans” http://t.co/BLnpqlJUqv #plutonash
(6) TOP(Hillary Clinton)|(Pred1(Hillary Clinton), Pred2 (running for Americans)
(7) “@Morning_Joe: Poll: Hillary Clinton dominates Iowa caucus http://t.co/3JqlHcfVEQ”
(8) TOP (Hillary Clinton)|(Pred1 (Hillary Clinton), Pred2 (dominates Iowa caucus)

These examples illustrate that information structure, and in particular the topic comment relation, is expressed in terms of the same basic syntax-semantic structure, which is independent of specific domains of interpretation, for example finance (here, publicly traded stocks) and politics (here, presidential campaign).

Information structure is asymmetrical because the R-expressions in the topic and the comment position cannot be interchanged without altering the structure and the interpretation. For example, if the R expressions in (7) would be inverted, we would obtain Iowa caucus dominates Hillary Clinton, which neither preserves the structure nor the semantics of (7).

Asymmetry is a universal property of linguistic relations, including argument structure, event structure and operator-variable structure (Chomsky, N. 1995. The Minimalist Program. Cambridge, Mass.: The MIT Press. Di Sciullo, A. M. 2005. Asymmetry in Morphology. Cambridge, Mass.: The MIT Press. Kayne, R 1994. The Antisymmetry of Syntax. Cambridge, Mass: The MIT Press. Moro, A. 2000. Dynamic Antisymmetry. Cambridge, Mass: The MIT Press). It is also a universal property of information structure.

The present system 10 relies on the universal asymmetrical relation between the restrictor and the nuclear scope in the information structure underlying the sentences of a text. This is not the case for current bag-of words and machine learning techniques that are not sensitive to this fundamental asymmetry.

Individual languages differ with respect to the way the topic-comment relation is articulated in sentences. Languages such as Chinese and Japanese are discourse oriented and topic prominent. In Japanese the particle wa identifies the topic of a sentence and the particle ga identifies the comment. In Japanese, the topic marker wa is attached not only to a nominal constituent but also to a prepositional constituent or a clause, forming the information structure of a sentence. Languages such as English are sentence oriented and subject prominent (Li, Charles N. and Thompson, S. A. 1976. “Subject and Topic: A New Typology of Language”. In Charles N, Li. Subject and Topic. New York: Academic Press, p. 475. Huang, James. 1984. On the distribution and reference of empty pronouns. Linguistic Inquiry, 15, 531-574. Rosen, S. T. 2007, “Structured Events, Structured Discourse”. In Ramchand & Reiss. The Oxford Handbook of linguistic Interfaces. Oxford: Oxford University Press.). There are no morphological topic markers on English constituents. The topic generally occupies the left edge of a sentence. This is the case in active sentences, such as (9), as well as the topicalized and cleft structures in (10). However, an adjunct such as the name of a place for example does not qualify as a topic, as it is the case for China in (11a) and New Hampshire in (11b). Moreover, the topic is never a pronominal element, a personal pronoun, an expletive or a quantifier, as the examples in (12) illustrate. Finally, the examples in (13) illustrate that a topic is a complete R-expression, and that it can be the antecedent of a pronoun. In (13(d)), the antecedent of the pronoun her is Hillary Clinton.
(9) a. $AAPL. [The iphone6] is a good buy.
   b. $AAPL. [The iphone6] is better than the Samsung Galaxy.
   c. [GOP Women] are talking.
   d. [GOP Women] are taking on Hillary Clinton.
(10) a. $AAPL. [The iPhone6], I'll buy ______ today.
   b. $AAPL. It's [the iPhone6]that I want to buy ______.
   c. GOP Women, I'll interview ______ today.
   d. It's GOP Women that I want to interview ______.
(11) a. $AAPL. [The iphone6] is likely to ______ be attractive in China.
   b. Two polls show [Hillary Clinton] with leads over Bernie Sanders in New Hampshire.
(12) a. $AAPL. I like [the iPhone6]
   b. $AAPL. It seems that [the iPhone6] is very popular.
   c. $AAPL. Everyone likes [the iPhone6].
   d. I like [Hillary Clinton].
   e. It seems that [Hillary Clinton] is very popular.
   f. Everyone likes [Hillary Clinton].
(13) a. $AAPL. [The screen of the iPhone6] is the best screen I have seen so far.
   b. $AAPL. I like [the screen of the iPhone6]. It is bigger than big.
   c. Could [Women's Magazines] Be Hillary Clinton's Secret Weapon In 2016?
   d. [Hillary Clinton], in South Carolina, reminds black women of her support for Obama.

The examples above illustrate that topic identification is syntax-semantic dependent. The topic identification system of the present system, as implemented by the topic calculator and topic inference engine, relies on syntax-semantic asymmetrical structure. Thus, the present invention does not rely on tagged tokens frequencies for topic identification. It relies on the structural prominence of R-expressions in syntax-semantic trees. Contrary to common practice, the invention is based on the premise that topic identification applies to the underlying syntax-semantic structure of short social media messages and computes the topic value for R-expressions occupying prominent asymmetrical positions. In active sentences, the topic is the most prominent R-expression. The notion of most prominent R-expression is defined in (14) in terms of the asymmetrical c-command relation, repeated here in (15), between the nodes of a syntax-semantic tree.
(14) Most prominent R-expression in T
   In a binary branching tree T, an R-expression is the most prominent in T iff it is the only category whose maximal projection asymmetrically c-commands the other R-expressions projections in T.
(15) a. C-command: X c-commands Y iff X and Y are categories and X excludes Y, and every category that dominates X dominates Y.
   b. Asymmetric c-command: X asymmetrically c-commands Y, iff X c-commands Y and Y does not c-command.

Given the definition (14), the R-expressions in square brackets in (9)-(13) qualify as the most prominent R-expressions in (9)-(13).

The topic calculator 20 assigns topic scores to R-expressions on the basis of their structural prominence in their parse tree, there being Name Entities (NE) related to the knowledge base of the keyword used to ingest the social media messages, as well as their membership in pronominal anaphoric chains. For example, in the examples in (9)-(13) above, the iphone6, the screen of the iphone6 are part of the NE of the publicly traded stocks knowledge base, and Hillary Clinton, Obama and GOP (Grand Old Party/Republican party) are part of the NE of the political knowledge base. The occurrence of a given nominal expression in a syntactic prominence relation and its membership to the knowledge base of the keyword contributes to its topicality. Moreover, in cases where a short social media message includes more than one sentence, the topicality of an R-expression may also signaled by the fact that this R-expression is the antecedent of a pronominal anaphor. This is the case in (13b) and (13d), where the screen of the iPhone6 in the first case, and Hillary Clinton in the second case, are the antecedents of pronouns. The rules for the calculation of the topics score in short social media messages are provided below in Section 5.

The multi-layered system 10 depicted in FIG. 1 ingests content from multiple social media sources based, on user-specified criteria, which take the form of keywords. The ingest component 12 consumes, acquires or gathers a wide range of social media messages and immediately filters the messages as will be explained below in greater detail. The ingest component 12 is a data acquisition module. The ingest component 12 allows the system 10 to automatically import raw social media messages, for example, social media messages from Twitter or other social media sites. The data, that is, the raw social media messages, is acquired on the basis of a predefined set of keywords or combination of keywords the system 10 has been programmed to look for.

The filtered social media messages are then subjected to natural language processing via NIP processor 16 based upon lexical databases 26, 28, 30, 32 of both specific sentiment terminology, such as the stock specific lexicon (Stock-Lex), politic specific sentiment terminology (Pol-Lex), as well as other terminologies, such as the city specific sentiment terminology (City-Lex), as well as general, non domain-specific, sentiment terminology (Sent-Lex), City specific sentiment, focuses on sentiment with respect to salient cities, such as Dubai. For this specific domain of interpretation, the system 10 detects what people say about cities on Social Media, and what the sentiment is about specific topics in the context of those cities. City specific sentiment will enable local authorities, national governments and the media to get a detailed perspective on how Social Media perceives a city in general and also a dissection of each topic pertaining to that city (e.g. Airports, Restaurants, Bars, Security).

The system 10 further includes a filter 14 that eliminates noisy elements for the NLP processor 16, such as URLs and hash tags, and identifies the name entities that are part of the message; a part-of-speech (POS) tagger 34 assigning lexical categories to the tokenized messages; a morphological lemmatizer (MORPH) 36 deriving the canonical form of lexical items in order to enable the lexical lookups; a partial parser (PARSE) 38 recovering the structure of the main constituents.

The filtered and NLP processed social media messages are next processed by the sentiment calculator 18 and sentiment/topic inference engine 40. The sentiment calculator 18 and sentiment/topic inference engine 40 apply information from knowledge bases 42, 44, 46, 48 respectively relating to the knowledge of the stock market world, the knowledge of the political world, the knowledge of the cites of the world as well as other common knowledge bases. The sentiment calculator 18 calculates sentiment composition ally in its syntactic context and the inference engine. The sentiment/topic inference engine 40 consists of a knowledge base and a set of inference rules. The architecture of the sentiment/topic inference engine 40 is universal. It can be parameterized for sentiment extraction and for topic extraction, as well for any domain of interpretation. The sentiment/topic inference engine 40 fine-tunes the sentiment and the topic calculations using world knowledge and domain specific knowledge, such as the knowledge of the stock market, the knowledge of politics, the knowledge of cities and any other specific knowledge bases 42, 44, 46, 48 maintained by the system.

The filtered and NLP processed social media messages are also processed by the topic calculator 20 and sentiment/topic inference engine 40. The topic calculator 20 calculates the topic value of prominent R-expressions in real-time according to their syntax-semantic prominence in the social media message they are part of, to their membership in knowledge bases as well as their occurrence in anaphoric chains. The sentiment and the topic calculators 18, 20 rely on the properties of the sentiment/topic inference engine 40 to provide sentiment and topic per keywords.

Both the sentiment calculator 18 and the topic calculator 20 apply to the asymmetrical relations in the parse trees of the social media messages. The overall system 10 calculates both topics and sentiments with respect to keywords in real-time. Topic-sentiment pairs support finer grained decision-making behaviors and provide structured indicators of trends.

The results of the sentiment calculator 18 and the topic calculator 20 are then presented to the user via a reaction indicator 22 and topic indicator 24 in the form of a graphical user interface(s) upon a computer monitor which displays sentiment per keyword information or topic per keyword information, see (55), (57) and (59) in Section 7.

The following paragraphs describe the main features of each component of this architecture.

### 1 The Ingest Component

Simple and complex keywords are used for ingesting the social media messages, according to the requirements of the users. The set of keywords is defined in terms of universal categories that can be parameterized according to specific domains of interpretation, including finance and politics. Depending on the nature of the domain of interpretation different strategies for ingesting a large number of relevant social media messages are used.

The hardware used for ingest are standard off the shelf computers gathering and processing social media messages using pre-determined keywords. The techniques used for collecting social media messages must be parameterized to different domains of interpretation, including finance, politics and other domains, in order to take into consideration the requirements of the users, including stock traders, political campaign organizers and other users. The requirements of pollsters, members of political parties and political campaign organizers are illustrated in Section 1.1, and the strategies to collect social media messages regarding specific political actors are illustrated in Section 1.2. The requirements of stock traders are illustrated in Section 1.3, and the strategies for collecting social media messages regarding specific assets are illustrated in Section 1.4.

### 1.1 The Requirements of Pollsters, Members of Political Parties and Political Campaign Organizers

From the perspective of pollsters, members of political parties and organizers of political campaigns, there must be a measurable correlation between sentiment (as manifested in social media messages) and popular vote. There is usually a strong positive correlation between a positive image of a candidate and the election of that candidate by popular vote; as well as there is a negative correlation between a negative image of a candidate and the election of that candidate. Such correlations are needed to support reliable election predictions. Current research results show that Twitter data analyzed with sentiment analysis better reflects the popular vote than the volume of messages. Washington. A., Para F, Thatcher, J. B., LePrevost, K. and Morar, D. 2013. “What is the correlation between Twitter, Polls and the Popular Vote in the 2012 Presidential Election?” APSA 2013 Annual Meeting Paper, American Political Sciences Association 2013 Annual Meeting. The sentiment and topic values of social media messages on politicians, that are running for the 2016 US presidency, such as Hillary Clinton, Marco Rubio, Jeb Bush and Donald Trump, constitute valuable data that can be used to make prediction on the outcome of the 2016 election.

### 1.2 Collecting Social Media Messages Regarding Specific Political Actors

The set of keywords for participants in political events, such as the candidates in a political campaign leading to an election, can include the name of these participants, entity X in (16), and well has names of general attributes that such participants might attempt to own or that are relative to different political categories, such as demographic groups, battleground states, key political people, attacks and partisanships, entity Y in (17). Thus, there are at least two different strategies for ingesting a large number of relevant social media messages that can be employed:
(16) single key-word template: entityX and exclude list of irrelevant combinations.
(17) binary key-word template of the form: entityX+entityY

The strategy in (16) can be used to ingest social media messages on candidates in the 2016 US presidency campaign. For example, the keyword “Hilary” will also cover its variant “Hillary+Clinton”. Proper names are rigid designators, and they have limited referential ambiguity, thus there is no need, in the case at hand, for an exclude list. This may be the case for names of assets, as well discussed in 1.4 below. Strategy in (17) can be used for mining sentiment on Hillary Clinton with respect to different political categories, including the ones aforementioned. Thus in this second strategy ‘Hillary’ and an expression related to the aforementioned political category can be used as keywords. This second strategy allows to collect social media message on Hillary Clinton and economy, on Hillary Clinton and key political people, such as Obama, Bill Clinton and jeb Bush, on Hillary Clinton and battleground states, such as Arizona, Colorado and Florida, on Hillary Clinton and demographic groups, such as African American and Asian, on attack corridors, such as Hillary Clinton and Benghazi, and so on. These strategies for ingesting social media messages provide relevant data for topic and sentiment computation.

### 1.3 The Requirements of Stock Traders

From a stock trader's perspective, there must be a measurable and significant correlation between sentiment (as manifested in social media messages) and price movement. The correlation can be positive or negative. For example, there is usually a strong positive correlation between the performance of the financial sector and the S&P 500 and there is a negative correlation between Volatility and the S&P500. As there needs to be enough social media, for example, tweet, volume to provide confidence that the aggregate sentiment will have enough mass to move the asset price. In many cases, collecting all tweets pertaining to a single stock symbol will NOT meet the volume threshold that would produce a reliable correlation between sentiment and price. This can be mitigated by trading assets that have measured price correlations over an extended period of time by ingesting and processing tweets that pertain to all price-correlated assets and then using the sentiment derived from the above described aggregation of tweets to trade each individual asset

### 1.4 Collecting Social Media Messages Regarding Specific Assets

The set of keywords for specific assets is defined in terms of generic categories that can be parameterized according to the finance domain. Depending on the nature of the asset, different strategies for ingesting a large number of relevant social media messages are used. For example, the following strategies may be employed:
(18) single key-word and exclude list of irrelevant combinations
(19) binary key-word template of the form: entityX+predicate

An example of the strategy (18) is used for Crude Oil, where only one keyword is used ‘oil’ and a very large exclude list includes expressions such as Soya oil, olive oil etc. In the case of commodities, such as Gold, strategy (19) is preferred. The strategy is to have a large include list made up of binary expressions including the word gold, the entity, and another word, a predicate, as in gold industry, gold news, gold investor, gold invest, gold investment, gold plunge, gold raise, gold plunged, gold raised, gold plunging, gold raising, gold decline, gold declined, gold declining, gold rally, gold rallied, gold rallying, gold fall, gold falls, gold falling, gold fell, etc. A large exclude list is still necessary to exclude for example jewelry items and colors. Strategy (12) can be used for other commodities; by substituting names of other commodities to the variable in (13) and keeping constant the set of predicates. Thus a very similar set of keywords may apply to other commodities. This refined key-word strategy for ingesting relevant social media messages increases the volume of ingested social media messages that will be fed into the other components of the systems, described in the following paragraphs.

### 2. The Pre-Processing Modules

### 2.1 The Language Normalizer

The ingested social media messages may include messages in a language other than English. The language normalizer 13 verifies the language of an incoming message and normalizes its form. For example, the form of the ingested social media message in (20) will be normalized as in (21), by converting capitals into small caps.
(20) a. $AAPL. I will buy AAPL shares today.
   b. $aapl. i will buy aapl shares today.
(21) a. Hillary Clinton Talks Economy, Her Story, at First Campaign Rally #Obama
   b. hillary+clinton talks economy, her story, at first campaign rally #obama

Language identification is a prerequisite for the NLP processing, as the overt syntactic properties vary between languages, as well as the form and content of the lexical items. It is thus necessary to ensure that the message processed by the NLP pipeline will be English messages. Moreover, language identification is crucial for the Topic calculus as explained below Section 5. Languages vary with respect to the morpho-syntactic encoding of information structure.

### 2.2 The Filter Module

The filter module 14 is a pre-NLP processing module that brings social media messages as close as possible to expressions in natural language by eliminating expressions that are not part of current use of language. For example, the filter module 14 eliminates URLs and hash tags at the periphery of the social media message, normalizes symbols and abbreviations, for example q1|1q|1^{st} quarter|is replaced by ‘first quarter’.

The filter module 14 also performs sentence detection on the basis of typographic cues. This is a necessary step in the computation; social media messages may include more than one sentence. As the topic calculus is sentence bound, sentence boundary delimitation is necessary. For example, the filter applies to (22a), replaces the URL by a period, eliminates URLs, identifies the name entities, NE:aapl, NE:ipad_PRODUCT, and yields (22b). The filter also applies to (23a) and identifies the name entities, NE: Hillary_clinton_PERSON.previousl.
(22) a. $AAPL. ipad sales are cratering http://stks.co/tliBt
   b. aapl_$aapl//NNP NE:aapl. Ipad//NNP NE:ipad_PRODUCT sales are cratering.
(23) a. #hillary clinton for makes America's economy good, give the vote hillary clinton
   b. hillary_clinton//NNP NE (hillary_clinton_PERSON) for makes America's economy good, give the vote hillary+clinton//NNP NE (Hillary_clinton_PERSON)

Thus, the filter 14 takes an ingested social media message as its input and transforms the social media message in a less noisy English expression as well as it identifies NE. The next paragraphs describe the modules of the NLP processor 16.

### 3. The NLP Processor

### 3.1 The Sent-Lex (Sentiment Lexicon)

The Sent-Lex 32 (that is, the knowledge base of general, non-domain specific, sentiment terminology) is a hand-crafted repository of the most frequent lexical items and phrases collected from ingested twitter messages, as well as from specialized vocabularies. The items vary according to the domain of application, e.g. finance, politics, security, pharmaceutics, etc. Words that are not sentiment bearing, such as definite articles and auxiliaries, are not part of the Sent-Lex 32. In the event-driven approach to sentiment mining, sentiment is associated to event denoting verbs and nouns, as well as with sentiment-bearing modifiers of events or of participants of the events.

The lexical specifications are designed to be parametrized to specific domains of application. The generic format of the lexical entry includes the lexical item, followed by fields of lexical specifications. The first field specifies the category of the item, the second field specifies its polarity, the third field specifies its lexical strength, and the fourth field specifies the polarity of the semantic arguments of the items, if applicable.
(24) Lexical item, category, polarity, strength, argument's polarity and strength

Thus, the lexical items, phrases and their features are stored in a lexical database. Lexical items are associated with a category tag, an inherent polarity value, an inherent strength value, and for some items, polarity and strength values are also associated to designated argument structure variables:
(25) Categorical tag: NN, VB, RB, . . . .
   Polarity values: +, −, n
   Strength values: 1, 2, 3, where 1 is min. and 3 is max.
   Argument structure values associated to the argument variables:
   (x,y,z,w).

The categories, nominal (NN), verbal (VB), adjectival (JJ), adverbial (RB) and their sub-categories, are thus intrinsically associated to polarity (+, −, n), and strength (1, 2, 3).

As will be appreciated based upon the following disclosure, the Topic calculus proceeds in parallel to the sentiment calculus and is sensitive to R-expressions, such as proper nouns, common nouns and definite descriptions. Functional categories such as pronouns, either personal, possessive, expletive, relative or interrogative pronouns, are associated with a categorical tag (PRP). However, functional categories such as PRP are not associated with sentiment polarity or sentiment strength values, or to argument structure values. This is also the case for constituents including proper nouns (NNP) and common nouns (NN), which have independent reference. The difference between nominal expressions with independent reference (NNP and NN) and nominal expressions that do not have independent reference, such as PRP, is established on the basis of their categorical tags.

### 3.2 The Stock-Lex & Pol-Lex (Specific Stock Trading Lexicon and Political Lexicon)

The stock-market specific lexical items and phrases populate the Stock-Lex 26 (that is, a database of stock specific lexicon), while the politics specific lexical items and phrases populate the Pol-Lex 28 (that is, a database of politic specific sentiment terminology). The sentiment calculator 18 applies to pairs of sentiment-marked items compositionally in their syntactic configuration. In its current form, the Stock-Lex 26 is the lexical repository consisting of the most frequent lexical items and phrases used in the ingested twitter messages, as well as most frequent items used in stock exchange in news wire such as the Financial Post. Similarly, the Pol-Lex 28 is the lexical repository consisting of the most frequent lexical items and phrases used in the ingested twitter messages, as well as most frequent items used in political discourse reported in news wire such as CNN, FOX NEWS, and The New York Times.

The specialized lexicons, including the Stock-Lex 26, the Pol-Lex 28 and the City-Lex 30 (that is, a database of city specific sentiment terminology) include a restricted set of domain specific items and expressions, associated with their polarity and strength, values. The polarity values are: positive, negative and neutral (+, −, n). The lexical strength associated to the lexical items ranges from 1 to 3, where 1 is the lowest value and 3 is the highest.

| | Stock-Lex | | Pol-Lex |
|---|---|---|---|
| (26) | Sample of the NN database | (27) | Sample of the NN database |
| | President, NN, n, 1 | | leader, NN, +, 3 |
| | asset, NN, n, 2 | | leadership, NN, +, 3 |
| | bull, NN, +, 3 | | legalization, NN, n, 1 |
| | bear, NN, −, 3 | | legislature, NN, n, 1 |
| | bust, NN, −, 3 | | lobby, NN, n, 2 |
| | buy, NN, +, 3 | | lobbyist, NN, n, 2 |
| | call, NN, +, 3 | | loser, NN, −, 3 |
| | elite, NN, +, 1 | | loss, NN, −, 3 |
| | City-Lex | | |
| (28) | Sample of the NN database | | |
| | traffic jam NN, −, 3 | | |
| | public attraction, NN, +, 3 | | |
| | museum, NN, +2 | | |
| | city park, NN, +, 3 | | |
| | health club, NN, +, 2 | | |
| | ATM, NN, +, 2 | | |
| | dump area, −, 3 | | |

Only stock-specific nominal and verbal expressions are part of the Stock-Lex 26, only political-specific nominal and verbal expressions are part of the Pol-Lex 28, only city-specific nominal and verbal expressions are part of the City-Lex 30, likewise for adjectives and adverbs. The Common Sent-Lex 32 includes the lexical items that are not specific of stock exchange or politics, or to any additional domain of interpretation.

Stock objects (tickers, company names, product names, etc.) have a neutral polarity and have no associated strength value. Specific Stock objects, for examples ticker symbols such as $AAPL, company names, such as Apple Inc. and product names, such as iphone6 are part of the knowledge base for $AAPL and are recognized as Name Entities early in the computation, at the filter level, as illustrated above.

The Stock-Lex 26 is a repository of the most frequent sentiment-bearing noun, verbs, adjectives and adverbs used in social media stock market-related exchanges. Each lexical item is associated with a POS, a polarity and strength, as illustrated in (26). The Pol-Lex 28 is the equivalent for politics, as illustrated in (27), and the City-Lex 30 is the equivalent for Cities, as illustrated in (28).

The domain specific lexicons are handcrafted and contribute to the invention in providing sentiment specifications for event denoting items, and their dependents. The innovation is two-fold: i) it specifies sentiment values for other categories than adjectives, contrary to common practice; and ii) it specifies sentiment value for event denoting lexical items and their dependents, thus providing the lexical information used by the sentiment calculator for the compositional calculus of the sentiment-per-keyword.

### 3.3 NLP Processor

### 3.3.1 The POS Tagger

The topic calculus, like the sentiment calculus, applies to constituents in their syntactic context. In order to derive the syntactic context for the topic calculus, each incoming filtered social media message is tokenized, and each token is assigned a POS by a tagger 34. Brill Tagger is used, as it is sensitive to the lexical properties and distributional properties of lexical items in natural languages. A POS tagger 34 is necessary to identify the lexical items and the syntax-semantic constituents that contribute to the topic and to the sentiment calculi. In the case of the sentiment calculus, these categories are adjectives (JJ), adverbs (RB), as well as event denoting verbs (e.g., to upgrade) and nouns, e.g. (e.g., an upgrade). In the case of the topic calculus, nominal expressions proper names (nnp) and common names (nn, nns) in their maximal nominal projection (nx) are relevant. Thus, the POS identification (29) of the elements of the event structure (28), reduces the complexity of information extraction, and contributes to the precision of both the topic and the sentiment calculi. The event structure is embedded in a domain of interpretation (D), such as finance, politics or tourism discussed further below, which is not associated to any POS.

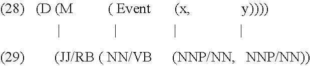

Thus, the POS Tagger 34 applies to the ingested filtered messages, tokenizes the string and assigns part of speech to the tokens on the basis of a set of lexical and contextual rules, accounting for the distribution of categories in natural language texts. To illustrate, Brill applies to (30a) and (30a) and derives the annotated tokenized strings in (31b) and (31b). Likewise for the examples in (32) and (33).
(30) a. $AAP. It's AAPL shares that I want to buy today.
   b. aapl_$aapl/NNP./. Its/PRP$ aapl_aapl/NNP shares/NNS that/IN I/PRP wan/JJ to/TO buy/VB today/NN./.
(31) a. $AAP. I like the screen of the iPhone6.
   b. [aapl_$aapl/NNP./.I/PRP like/VBP the/DT screen/NN of/IN the/DT iphone6/NNP./.]
(32) a. Hillary Clinton for makes America's economy good.
   b. Hillary Clinton/NNP for/IN makes/VBZ America/NNP's/POS economy/NN good/JJ./.
(33) a. Crowds gather for Hillary Clinton's 2016 campaign kickoff rally Hill: “Everyday Americans need a champion”.
   b. Crowds/NNS gather/VBP for/IN Hillary+Clinton/NNP's/POS 2016/CD campaign/NN kickoff/NN rally/NN Hill/NN: Everyday+Americans/NNS need/VBP a/DT champion/NN./.

In this relational approach to topic mining, sets of POS are related to the elements of event structures (28) & (29). The identification of the POS of the tokens of the filtered social media messages reduces the complexity of Topic detection as well as it contributes to its efficiency.

### 3.3.2 The Parser

The tokenized and POS annotated messages are fed to a partial parser 38 that recovers the main syntactic constituents of the messages. The partial parser 38 is the Cass parser, Abney's cascaded FST (Finite State Transducer) to recover the main syntactic constituents on the basis of the tokenized and POS annotated syntactic representations of social media messages, as illustrated in (34) and (35) with the parse trees for the examples in (30) and (33).

```
(34)  [nx
      [nmp aapl_$aapl]]
    [per .]
    [nx
      [prps Its]
      [nn_cpd
        [nnp aapl_aapl]
      [nns shares]]]
  [comp that]
  [nx
    [prp I]]
  [ax
    [jj want]]
  [infp
    [inf
      [to to]
      [vb buy]]
    [day-pr today]]
  [per .
(35)  [c0
      [nx
          [nns Crowds]]
      [vx
          [vbp gather]]]
    [pp
      [in for]
      [np]
        [nx
            [nnp hillary+clinton]]
    [pos 's]
    [nx
      [cd 2016]
      [nn_cpd
        [nn campaign]
        [nn kickoff]
        [nn rally]]]]]]
  [per .]
```

Partial parsing is designed for use with large amounts of noisy text. Robustness and speed are primary design considerations. Not all NLP applications require a complete syntactic analysis. Light parsing is used in Information Retrieval as well as Information Extraction applications, such as facts and sentiment mining, where finding simple nominal and verbal constituents is enough. Full parser provides more information than needed, and are more prone to error when expected information is missing, as it is generally the case in social media messages, where syntactic reductions and truncation are necessary to convey meaning within the limit of 140 characters. The main properties of the sentiment calculator and topic calculator are described in the following sections.

### 4. The Sentiment Calculator

A sentiment is an integer, which can be either positive or negative, computed on the basis of the application of the rules of the sentiment calculus to pairs of lexical items in their local syntactic context; for example, nouns (that is, nominal lexical items) representing assets and nouns/verbs/adjectives (that is, nominal, verbal or adjectival lexical items) representing sentiment in the form of polarity and strength. The computed sentiment value ranges within a pre-established scale. The sentiment calculator 18 uses social media messages for the real-time evaluation of the participants of events, such as publicly traded equities and commodities or candidate popularity in electoral campaigns, wherein a sentiment is a positive or negative integer computed based upon pairs of lexical items in local syntactic context. In its most basic components the sentiment calculator 18 employs a mechanism for determining lexical polarity in social media messages and a mechanism for determining a strength value of lexical items and phrases used in social media messages.

The sentiment calculus employed by the sentiment calculator 18 applies to the output of the annotated Cass tree produced by the partial parser (as discussed below). It compositionally derives the sentiment associated to entities in the event denoted by the expression they are part of. The sentiment logic is a compositional calculus deriving the sentiment value of a relation on the basis of the sentiment values of its parts.

In the specific domain of stock-market exchanges, the sentiment logic calculates sentiment values per asset with respect to stock market events described by the incoming social media messages. Namely, it calculates the sentiment with respect to given assets, as they occur is stock events. In the specific domain of politics, the sentiment logic may calculate the sentiment value per candidate with respect to the political events described by the incoming social media messages. Namely it calculates the sentiment with respect to the candidate names that occur in the political events. The properties of the sentiment calculator 18 for the analysis of social media messages on stock-market exchanges are described herein, and it is appreciated that the properties of the sentiment calculator 18 for the analysis of social media messages on politics or on other domains such as cities are similar.

As discussed above, the social media messages relating to an asset are gathered by a set of keywords used for ingesting the social media messages. The sentiment calculus is based on the lexical polarity and strength value of the lexical items and phrases defined in the Stock-Lex 26 and how they are syntactically organized in the Cass tree. The maximal local domain for the application of the calculus is the sentence; the minimal local domain is the smallest constituents including the keywords standing for the asset. The sentiment calculus applies locally to the constituents including the asset within the sentences of the message. The Cass parser derives the syntactic constituents of the sentences, including the adjectival (ex), as well the nominal (nx) and the verbal (vx) constituents.

The polarity and strength rules apply to syntactic constituents in head-complement, modifier-modified, and subject-predicate relations, which are identified on Cass trees. These relations are defined as follows. A head of a constituent is a lexical item, such as a verb, e.g., hit, or a noun, e.g., acquisition, that makes the constituent it is part verbal (vx) or nominal (nx). A head selects a complement, which is a syntactic constituent such as a nominal phrase, e.g. the market in hit the market, and AAPL in the acquisition of AAPL. A modifier is an adjective or an adverb that modifies another constituent, a nominal constituent in the first case and a verbal constituent in the other case, e.g., strong market and strongly hit the market. The subject-predicate relation is the relation between a subject, generally a nominal constituent and a predicate, generally a verbal constituent, e.g., in the sentence AAPL hits the market. AAPL is the subject and hit the market is the predicate.

The sentiment calculus includes separate rules for calculating the polarity and the strength. They have the generic form of dyadic operators (Op (arg1, arg2)), and their specific form is dependent on the relation between arg1 and arg2, as well as the lexical polarity and strength values of the lexical items and phrases specified in the Stock-Lex 26.

### 4.1 Polarity (Pol)

Pol (arg1, arg2), where arg1 is a head and arg2 is a dependent. The rule applies locally in syntactic constituents/domains, e.g., nx, vx, cx, etc. It derives the polarity of constituents on the basis of the polarity of their parts and how they are syntactically related. The polarity rules apply in three universal syntactic relations defined above (that is, head-complement, modification (modifier-modified), and predication (subject-predicate) relation), according to the polarity of the parts of the relations. The Polarity rules include the following:

### Pol Rules:

Pol ([x] [y])=Compose ([x], [y]) as specified by the following rules:
(36) if (x is NEG) and (y is +), then Pol ( y=−) NEG, +=−no upgrade
   if (x is NEG) and (y is −), then Pol (y=n) NEG, −=n not bad
   if (x is NEG) and (y is n), then Pol (y=n) NEG, n=n no report
(37) if (Pol (x)=Pol (y)), then
   if (x is n) and (y is n), then Pol (y=n) n, n=n average result
   if (x is +) and (y is +), then Pol (x =+) +, +=+announce an upgrade
   if (x is −) and (y is −), then Pol (y=−) −, −==downgrade to sell
(38) if (Pol (x)≠Pol (y)), and
   if (x is +) and (y is n), then Pol (y=+) +, n=+impressive report
   if (x is +) and (y is −), then Pol (x=−) +, −=−impressive downgrade
   if (x is −) and (y is n), then Pol (y=−) −, n=−weak report
   if (x is −) and (y is +), then Pol (y=−) −, +=−missed rally
   if (x is n) and (y is +), then Pol(y=30 ) n, +=+average upgrade
   if (x is n) and (y is −), then Pol (y=−) n, −=−average depreciation

### 4.2 Strength (Str)

Str (arg1, arg2), where arg1 is a head and arg2 is a dependent. The rule applies locally in syntactic constituents/domains, e.g., nx, vx, cx, etc. It derives the strength of constituents on the basis of the strength of their parts and how they are syntactically related by the application of an arithmetic operation to the pair of arguments depending on the nature of the syntax-semantic relation and the polarity of the constituents. The strength rules apply to the lexical items and phrases in the three universal syntactic relations, and the strength is calculated on the basis of elemental arithmetic operations. The Strength rules include the following:

### Str Rules:

Function (arg1, arg2), where arg1 is a head and arg2 is its dependent

Str ([x] [y])=Compose ([x], [y]) as specified by the following rule:
(39) if (x is the head (h)) and (y is the complement (o)), then Str (x)+Str (y)
   if (x is the head (h)) and (y is the modifier (m)), then Str (x)+Str (y)

Function (arg1, arg2), where arg1 is a modifier and arg2 is the modified

Str ([x] [y])=Compose ([x], [y]) as specified by the following rules:
(40) if (x is JJ, RB) and (y is NN, VB), then Str(x)+Str (y)
   if (x is an JJ, RB) and (y is a JJ, RB), then Str (x)+Str (y)
   if (x is RB*) and (y is a JJ, RB), then Str (x)+Str (y)

It is appreciated that social media messages may include more than one sentence, may talk about more than one asset, more than one stock event, and they may express more than one sentiment. Computing blindly the sentiment valises of all the lexical items and phrases of social media messages, the resulting value is general and not necessarily asset specific. The sentiment calculator 18 is sentence bound. Moreover it calculates sentiment in the local syntax-semantic domain of an asset. Thus, it ensures that the specific sentiment with respect to a given asset conveyed by a message is calculated. It applies iteratively in the local domain of the constituent including the asset (keyword, set of keywords), e.g. OIL, or GOLD, and the expression of a stock event (e.g., “lose”, “gain”, “sell”, “buy”) or a sentiment (e.g., “high”, “low”).

The following trace for the tweet (41) illustrates the application of the sentiment calculator 22 that calculates sentiment-per-asset in the local domain of the targeted asset: Oil. The calculus assigned the value +3 to Oil, discarding the value of the computation for Canadian dollar, which is −5.

(41) Canadian dollar falls for second week. Crude Oil prices raises.

```
[root {oil: Positive,3.0,null}
[sen {_: Negative,5.0,null}
  [c {_:Negative,5.0,null}
      [c0 {_: Negative,3.0,null}
        [nx {_: Null,null,null}
```

| | |
|---|---|
| [jj [{_: Null,null,null}] | (Canadian)] |
| [nn {[_: Null,null,null}] | (dollar)] |

]

| | |
|---|---|
| [vx {_: Negative,3.0,null} | |
| [vbz [{_: Negative,3.0,null}] | (fails)] <<<< {−} |

```
      ]
    ]
    [pp {_: Neutral,2.0,null}
```

| | |
|---|---|
| [in [{_: Null,null,null}] | (for)] |

[nx {_: Neutral,2.0,null}

| | |
|---|---|
| [jj [{_: Neutral,2.0,null}] | (second)] |
| [tunit [{_: Null,null,null}] | (week)] |

```
          ]
        ]
      ]
```

| | |
|---|---|
| [per [{_: Null,null,null}] | (.)] |

```
    ]
    [sen {oil: Positive,3.0,null}
      [c {oil: Positive,3.0,null}
        [c0 {oil: Positive,3.0,null}
          [nx {oil: Null,0.0,null}
```

| | |
|---|---|
| [jj {[_: Null,null,null}] | (Crude)] |
| [nn [{oil: Null,0.0,null}] | (oil)] <<<< {K} |
| [nns [{__: Null,null,null}] | prices)] |

```
          ]
        [vx {_: Positive,3.0,null}
```

| | |
|---|---|
| [vbz [{_: Positive,3.0,null}] | (raises)] <<<< {+} |

```
        ]
      ]
    ]
  ]
]
```

This example shows that every step of the computation by the modules of the system 10 provides the structure for the application of the sentiment calculus. This calculus applies in local syntactic domains and provides an integer that represents the sentiment (polarity and strength) with respect to designated assets.

### 4.3 The Sentiment/Topic Inference Engine

The sentiment/topic inference engine 40 is part of an expert system, which is designed to process a problem expressing an uncertainty with respect to a decision, and to provide a decision, or a set of decisions reducing the uncertainty. The sentiment/topic inference engine 40 attempts to provide an answer to a problem, or clarify uncertainties where normally one or more human experts would need to be consulted.

The sentiment/topic inference engine 40 of the present system 10 is part of the pipeline and provides a mechanism to sharpen the accuracy of the sentiment computed, by bringing, for example, knowledge of the stock market world, knowledge of the political world, knowledge of cities, as well as common knowledge of the world into the computation. The sentiment/topic inference engine 40 includes a data structure, and a set of inference rules (if X then Y) relating facts to sentiments. This knowledge interacts with the domain-specific knowledge stored in the lexicon and used by the sentiment calculator 18.

The sentiment/topic inference engine 40 includes a data structure, a knowledge base that

uses some knowledge representation structure to capture the knowledge of a specific domain, for example a relational table relating entities in knowledge domains, and a set of inference rules applying to the entities in the relational table and drawing consequences. One advantage of inference rules over traditional programming is that inference rules use reasoning, which more closely resembles human reasoning. In the specific application of stock-market trade, the knowledge base 42 consists of a relational table relating stock entities (tickers, company names, products, etc.), stock events (e.g., upgrade, downgrade, etc.) and facts, extracted from news wire. In the specific application of politics, the knowledge base 44 consists of a relational table relating political entities (politicians, representatives, parties, etc.) political events (e.g. campaign, election, etc.) and facts, also extracted from news wire. In the specific application of city, the knowledge base 46 consists of a relational table relating city entities (industries, recreation, etc.) city events (e.g. festivals, sportive events, etc.) and facts extracted from news wire). The rules of the sentiment/topic inference engine 40 apply to the NE corresponding to the entities in the relevant relational table and infer sentiment values.

Let us illustrate with a first example from the stock-market domain:
(42) Damn you OPEC! Will this be the summer we finally see $5/gal at the pump??? I sure hope not. Kills any similar fun from, last summer

The knowledge base in this domain includes (43) below, and the inference rules (44) below, stating that if gas oil (at the pump) is inferior to $3 then the sentiment value is positive, +2, if the gas oil is superior to $3 then the sentiment value is negative, −2. This real world knowledge varies according to time and place.
(43) OPEC, oil, $X/gal, locations
(44) In “$X/gal” expressions, where X is a digit
   if X is inferior to 3 then polarity=+, and strength is 2
   if X superior to 3 then polarity=−, an strength is 2

Let us illustrate with a second example from the political domain:

The sentiment calculator 18 alone would not. derive the negative sentiment associated to the second sentence in (42). While the sentiment calculator 18 assigns the value neutral to questions, the sentiment/topic inference engine 40 assigns the sentiment value of −2.

Consider the following example from, social media in the context of the 2016 United States presidential election:
(45) @ScottWalker: “Hillary Clinton thinks you grow the economy in Washington” #RTM2015

The knowledge base in the political domain includes name entities (NE) for designated names, as well as the inference rules. Thus, the inference rule in (46) below states that if two NE of different political affiliation, one of which is the topic (TOP), are part, of the same domain of interpretation and that the VP is headed by a prepositional attitude verb, such as think and believe, then the sentiment value is negative, −, for NE-TOP, and if the NEs do not differ with respect to their political affiliation, the sentiment value is neutral n, for NE-TOP. The strength value of the whole message will be computed on the basis of the strength values of its parts by the sentiment calculus.
(46) In. “NEx . . . NE-TOP y . . . VPz . . . ”
   if x and y are not of the same pol-affiliation then polarity=−for y.
   if x and y are of the same pol-affiliation=n for y.

Consider finally the following example from social media in context of the 2020 World fair in Dubai:
(47) 100% solar-powered hotel to open in Dubai by 2017: IHG's new 170-room property at The Sustainable City . . . http://t.co/uRJdQC2d3x #ABnews

The knowledge base in the city domain includes name entities (NE) for designated names, including hotel names, such as IHG, as well as inference rules. Thus, the inference rule in (48) below states that if NE (TOP) has a large number of neutral attributes, then the sentiment value is positive, +, for NE-TOP, which is the Dubai Emirate IHG hotel in (47). The strength value of the whole message will be computed on the basis of the strength values of its parts by the sentiment calculus.
(48) In “DTx . . . NE-TOP y . . . DTz . . . ”
   if x and or y are neutral quantified (DT) nominal expressions≧100
   in the local domain of y, then polarity=+for y.

Dubai attracts increasing social attention as a major city in the Middle East, including for the fact that it will be hosting the World Expo 2020. The present invention detects what people say about Dubai and what viewpoint they convey. The information provided by the system on organizations such as cities, as valuable social and financial imports, including finance, politics and tourism.

Thus, the sentiment/topic inference engine 40 ensures that the sentiment is grounded in the real world, which varies according to time and place, events and participants to events. It contributes to the innovative technology, which leads to both simplify and sharpen decision taking in stock market transactions, as well as it may be used in other domains of interpretation, indicate for example the popularity of given candidates in electoral campaign or the degree of attractiveness of targeted cities.

Sentiment calculations in accordance with the present system are a result of the pipeline or multilayered embodied by the present invention that ingests social medial messages, identifies the language of the social media messages, and filters them from elements that are not part of natural language for which the system has been parameterized (here English). The POS tagger 34 and the partial parser 38 modules of the NLP processor 16 assign parts of speech to the tokens of sentences, and recover the structure they are part of. The sentiment calculus of the sentiment calculator 18 applies to the annotated structures and derives the sentiment value per asset based on the sentiment value of the event they are part of. Finally, the sentiment/topic inference engine 40 reduces uncertainly by relying on a relational database including knowledge of the world information and a set of inference rules.

The present sentiment calculation system includes computer implemented mechanism for obtaining and converting ingested unstructured social media messages regarding a plurality of objects/assets being tracked into a sentiment value for each object/assets. The sentiment value includes a polarity value and strength value derived from a natural language processing algorithm containing a database of lexical items and phrases related to the objects being tracked. The precise sentiment value per object is derived by the compositional calculus based on the sentiment valises of lexical items (and phrases) and their syntactic organization. The contextual sentiment value is based on the sentiment/topic inference engine 40 deriving a sentiment value with respect to knowledge of the world. The interaction of the sentiment calculus and the sentiment/topic inference engine 40 yields accurate sentiment in real-time. The sentiment cognitive-based calculus relates conceptual processing with natural language processing algorithm.

### 4.4 Sentiment Reaction Indicator

As discussed above, the data generated by the sentiment calculator 18 is applied to a graphical user interface 22 that combines sentiment and intensity data relating to the assets. The graphical user interface 22 includes moving graphic objects 56 displayed upon a monitor 58 that depict social media market/political/city sentiment; a timeline slider object 60; and a vertical bar chart object 62.

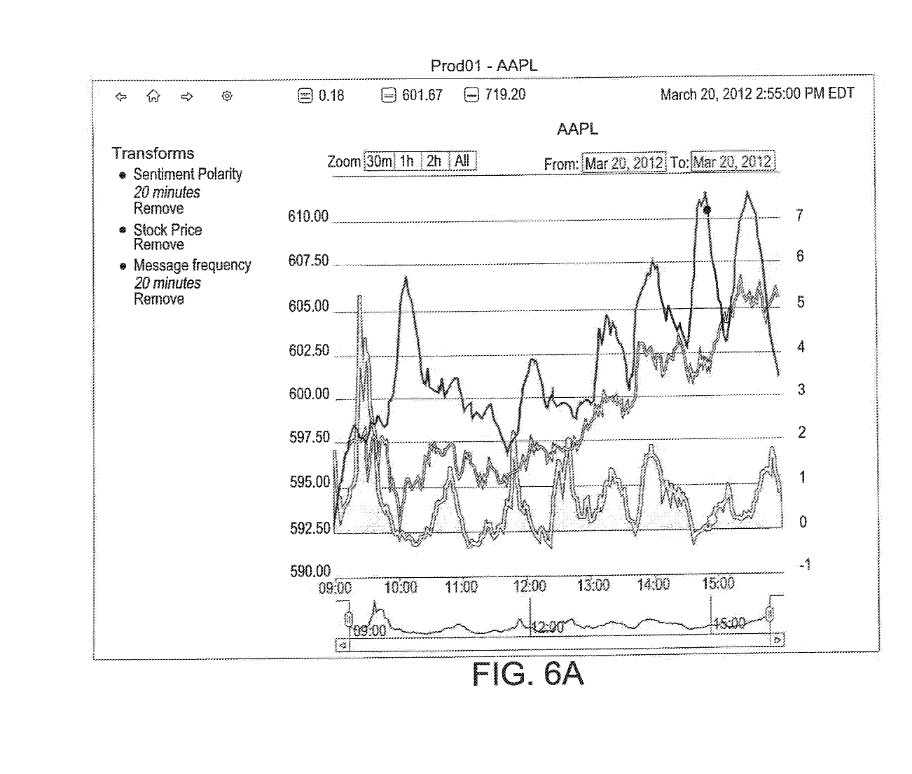

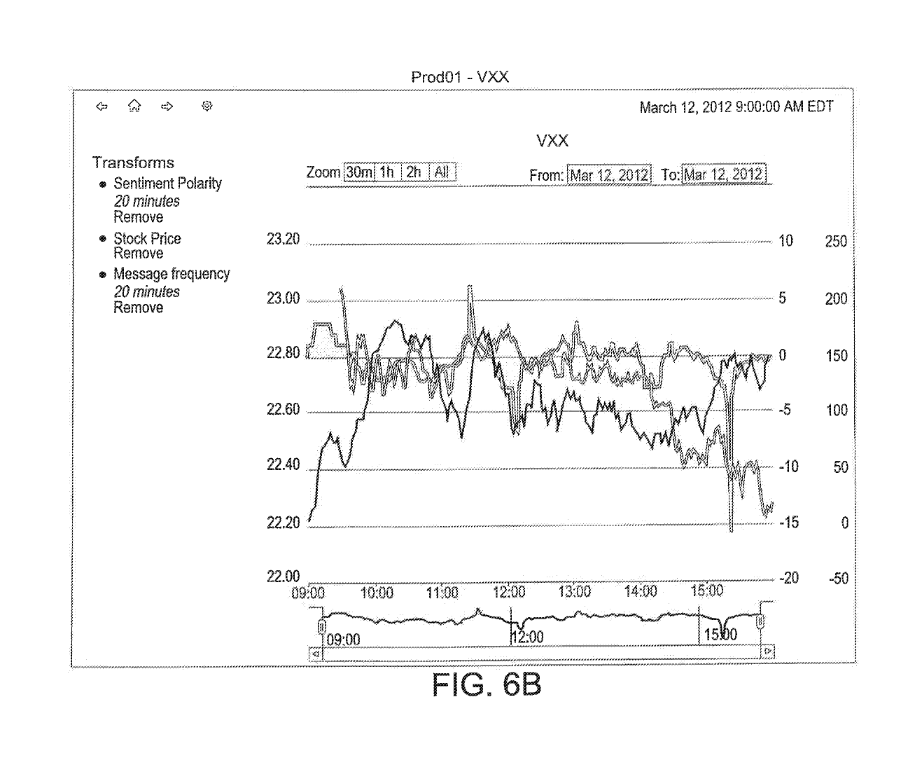

In accordance with the present invention, and as explained in the '104 publication, the graphical user interface 22 provides for the visualization of graphic objects 56 in the form of moving spheres where the sphere size and color depict social media market/political/city sentiment. The moving spherical graphic objects 56 shrink and grow based on intensity changes. The sphere color changes based upon social media sentiment polarity. The center sphere 56c represents the weighted sentiment average. Clicking one of the moving spherical graphic objects 56 results in the display of a chart (see FIGS. 6A & 6B) graphing (based on what the user selects) all or a choice of price, volume, social media frequency, social media sentiment, cross-correlation and a variety of price and sentiment derived technical indicators where stock information is being considered. For political sentiment a choice of political information, such names of political actors and dimensions including image, economy, partisanship, demography, etc. can be considered. As for city specific sentiment, a choice of features, such as airports, airlines, hotels, museums, expos, etc., can be considered. Sphere updates are based on a configurable time.

The graphical user interface 22 contains a time slider 60 to go back to a point in time and replay history. A vertical bar chart 62 graphs the social media sentiment when the graphical user interface 22 is in full screen mode.

The purpose of the reaction indicator is to provide a mechanism wherein hundreds of assets/political issues/city events can be tracked, but only those that are “interesting” based on preprogrammed parameters will float to the surface and draw the viewer's attention.

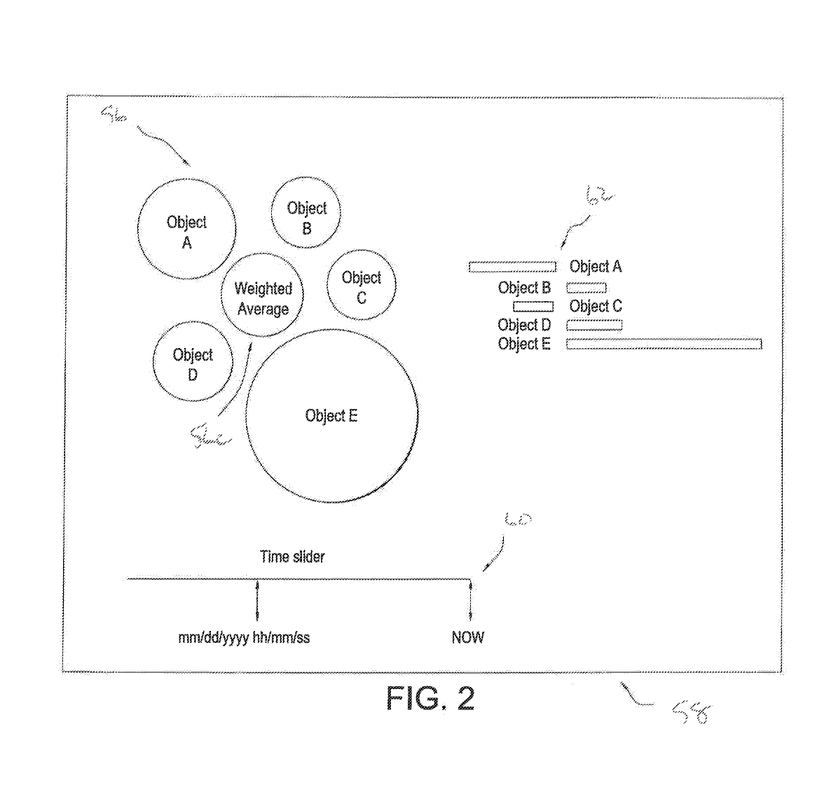

For example, for the stock-sentiment, and with reference to FIGS. 2, 3, 4, 6A, 6B and 7, the reaction indicator provides a graphical user interface 22 displaying three graphical areas of objects, moving spherical graphic objects 56, a timeline slider object 60 and a vertical bar chart object 62. It is noted the moving graphic objects may take shapes other than spheres, such as squares. Referring to FIG. 2, the spherical moving graphical objects are represented at 56, the timeline slider object at 60 and the vertical bar chart object at 62.

The reaction indicator polls a data stream containing mathematically computed values for social media intensity, social media sentiment, social media frequency, social media weighted average frequency and social media weighted average sentiment auto refreshing the moving spherical graphic objects and the vertical bar chart object based on a configurable polling time. Intensity is defined as the ratio of short term frequency divided by long term frequency. The mathematical computations for the data stream are calculated by an algorithm discussed herein in detail in a section related to cross correlation. The calculations are based upon information obtained from a multilayer pipeline architecture previously discussed.

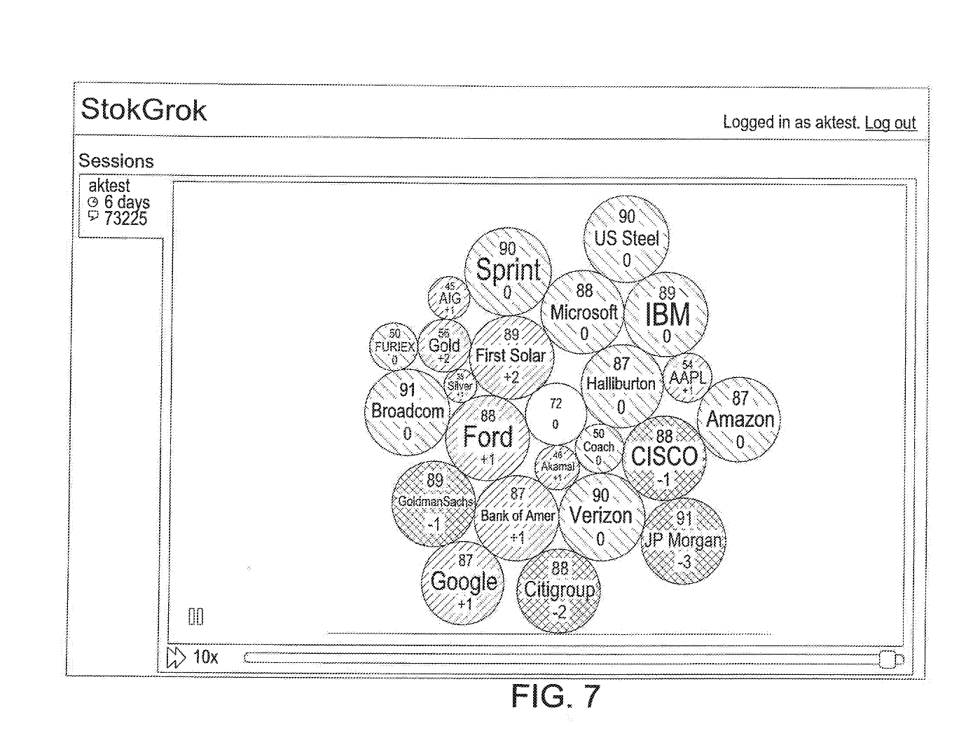

Referring to FIG. 7, the moving spherical graphic objects 56 shrink and grow based on the social media intensity attribute and are sized relative to each other taking into consideration the stage size and browser screen resolution. The color of the moving spherical graphic object 56 is based on social media sentiment polarity where polarity is defined as negative, neutral or positive. Each of the moving spherical graphic objects 56 displays a label, social media sentiment and social media frequency.

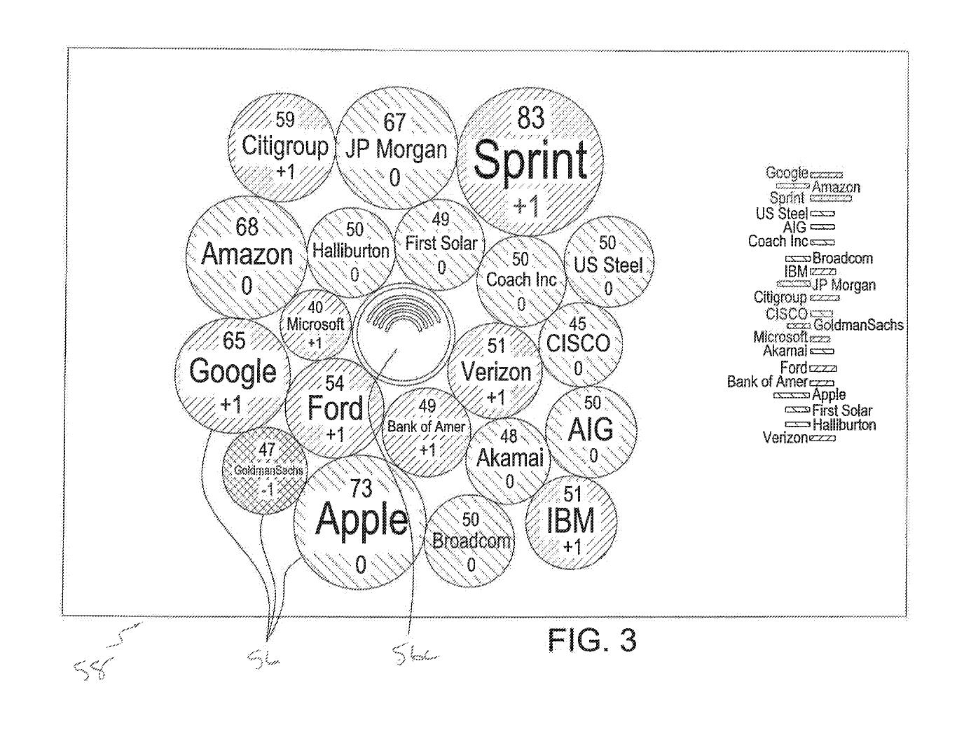

The center sphere object visualizes a weighted average of all sphere objects based on weights assigned to the spheres. Referring to FIG. 3, the weighted sphere object is represented at 56c. The weighted average sphere size is static relative to the other sphere objects, which shrink and grow, and displays weighted average social media sentiment and weighted average social media frequency, if sphere weights have been assigned. If sphere weights have not been assigned, the weighted average sphere object does not display any data. The weighted average sphere object 56c does not change color to reflect social media sentiment polarity. An example where weights may play a role is in the instance where the visualization represents an Exchange Traded Fund (ETF). An ETF holds assets such as stocks, commodities or bonds. The assets would be represented in the spheres. The weight for each asset assigned would represent the percentage in the ETF for an amalgamation of all assets.

The timeline slider object 60 visualizes a timeline where the date and time on the left represent the earliest date and time where data exists for the collection of moving spherical graphic objects 56. The date and time on the right represents current date and time. Moving to various points on the timeline slider object 60 move the moving spherical graphic objects 56 and the vertical bar chart object 62 to a point in time, pausing the real-time display, then replaying history. From the historical point in time selected, the moving spherical graphic object 56 and the vertical bar chart object 62 will poll the data stream coming from the sentiment calculator 18 for social media intensity, social media sentiment, social media frequency, social media weighted average frequency and social media weighted average sentiment from the point in time selected then rerun history as if it were happening real-time. Referring to FIG. 2, the timeline slider object is represented at 60.

The vertical bar chart object 62 utilizes the same data stream as the moving spherical graphic objects 56 to graph social media frequency, using the same color scheme as the spherical objects Referring to FIG. 2, the vertical bar chart object is represented at 62.

Clicking on a moving spherical graphic object 56 will launch a chart, graphing price, volume, social media sentiment, social media frequency, and cross-correlation auto refreshing based on a configurable time, e.g. every second as seen in the screen shots depicted in FIGS. 6A and 6B.

Each of the moving spherical graphic objects 56 display a symbol, such as an exclamation mark within the sphere, preferably in the center, when an alert has been triggered. Specifically, a trigger will result when sentiment and intensity variables cross certain thresholds, the related moving spherical graphic object 56 shall display an exclamation mark, signaling a potential trading opportunity; for example, when the sentiment and intensity for a given asset A exceeds a preprogrammed value indicating sell. An exclamation mark will be displayed in the center of sphere A alerting the operator to take action. The operator shall have the option of directly executing a trade via a combination of key clicks. The operator can program the reaction indicator to automatically place a trade. The operator can program the reaction indicator to send an alert via e-mail or text message.

In summary, the reaction indicator comprises a plurality of moving graphic objects 56 which change size and color based upon social media market sentiment, intensity and frequency captured and correlated in real-time from a stream of online social media messages related to a market/political/city segment. The moving spherical graphic objects 56 shrink or grow in size based upon the social media intensity attributed to each moving spherical graphic object 56 and the moving spherical graphic objects 56 change color based upon whether the social media sentiment attributed to each moving spherical graphic object 56 is positive, negative or neutral. The reaction indicator also provides a weighted average of all displayed moving spherical graphic objects displayed based on weights assigned to the objects prior to capturing social media streams is displayed among the plurality of displayed objects.

### 4.5 Sentiment, Intensity Cross-Correlation

As discussed above, once sentiment and intensity are fully appreciated, the present system 10 and method provides a mechanism for cross-correlating the sentiment and intensity data with the actual fluctuations with asset prices. As explained in the '104 publication, the present invention provides two methods to find patterns in a target real-valued time series by utilizing two other real-valued time series derived from a stream of social-media messages (Twitter for instance); sentiment and frequency.
The target is arbitrary. It represents a quantifiable property of the asset that is being tracked. For instance, we have applied the algorithm using stocks and commodities as asset, and their market prices as targets.
The sentiment, as defined previously, is relative to the asset underlying the target.
The frequency represents the volume of messages about the asset. It is derived from the sentiment time series and a parameter called the window size.

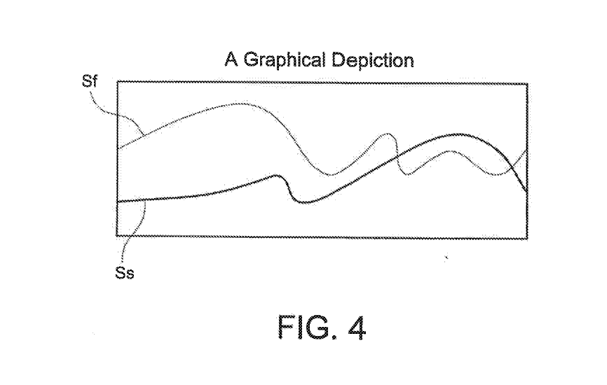

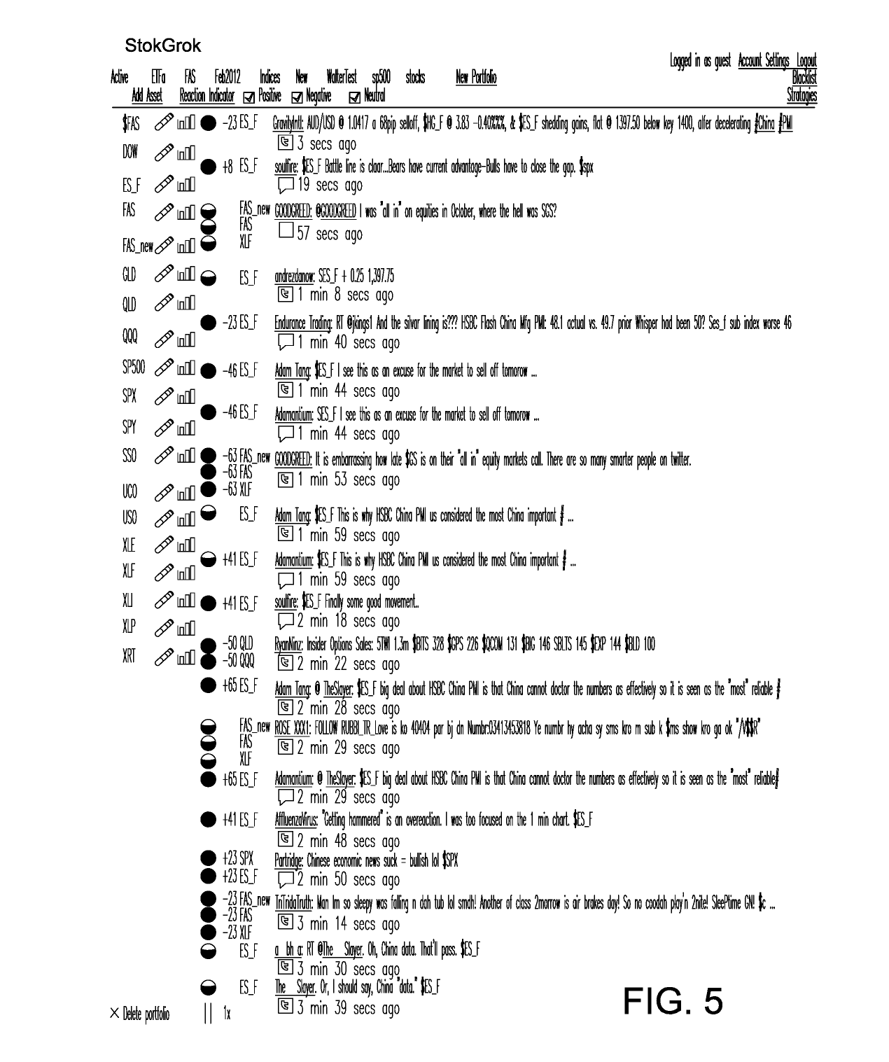

When supplied with a window size, and applied in real-time those methods have a predictive value on the target. For this reason the series used to find patterns in the target, such as the sentiment series and the frequency series, are called predictive. As shown in FIG. 4, the patterns can be depicted graphically on charts, together with the time series, to be used as a decision making tool.

The patterns can also serve as the input to an automated trading system to generate trading signals.

In the example shown in FIG. 4, the curves are a depiction of the sentiment time-series for the target (thick curve labeled Sₛ) and the sentiment-frequency time series (thin curve S_{f}). The calculation of the sentiment-frequency series will be described later.

From a visual inspection of the picture it is easy to see that the target is reproducing the bell pattern the sentiment-frequency curve had earlier. This provides the ability to predict the future move of the target better. Looking at the sentiment times series Sₛ for the target only, it seems the target is dropping sharply. However, using the pattern of the sentiment-frequency, one can anticipate that the target will soon experience a rather important rebound, This is the predictive value of the method. A visual inspection of FIGS. 6A and 6B will reveal that sentiment, despite NOT being derived from price, can show extremely strong correlation to price, either as a leading indicator or a supporting indicator, both scenarios being extremely relevant and useful to stock traders.

As will be appreciated based upon the following disclosure, the method of the present invention finds patterns in a target real-valued time series by utilizing sentiment and frequency derived from a stream of social-media messages, wherein the target represents a quantifiable property of an asset/political issue/city feature being tracked. The method includes identifying a target, which is a sampled real-valued time series; generating a sentiment time series, sₛ (which is plotted); generating a frequency time series plot, s_{f} (which is plotted); and determining a pattern based upon the sentiment time series and the frequency rime series.

### 4.6 Formal Definitions

As explained in the '104 publication, a real-valued time series is defined as a sequence of pairs (time (f), value (s)), also called points, ordered by increasing time. A simple time series could look like tills: [(12:36,27),(13:03,37),(16:34,88)].

Formally the space of time series is defined as Tₛ= [symbol] ( [symbol] × [symbol] , that is the set of finite subsets of [symbol] × [symbol] , whose elements are endowed with the total order <: (t, s), (t′, s′))∈( [symbol] × [symbol] [symbol] t<t′∈{true, false}.

Using the order <, each series s∈Tₛ is naturally mapped to the vector V(s)∈( [symbol] × [symbol] )^{#(s)} such that vᵢ is the i^{th} element of s. The vector of first components will be denoted by V₁(s) and the vector of second components V₂(s).

For example,

$$= \{ ( 12 \text{:} 36 , 27 ) , ( 13 \text{:} 03 , 37 ) , ( 16 \text{:} 34 , 88 ) \}$$

$$V ( s ) = [ ( 12 \text{:} 36 , 27 ) , ( 13 \text{:} 03 , 37 ) , ( 16 \text{:} 34 , 88 ) ]$$

$${V}_{1} ( s ) = [ 12 \text{:} 36 , 13 \text{:} 03 , 16 \text{:} 34 ]$$

$${V}_{2} ( s ) = [ 27 , 37 , 88 ] .$$

A semantic distinction is drawn between pulsated time series where points represent a punctual event (i.e., sequence of Diracs), such as the arrival of a message, and sampled time series that represent a discretization of a function that's defined at all times, such as the market price. It is thus natural to interpolate points of a sampled time series to try and recover the original function it was sampled from.

For example, for stock-exchange, the target is an arbitrary sampled real-valued time series. The algorithm has been applied with prices as target. The sentiment time series sₛ is generated by the Natural Language Processing (NLP) processor. It is a pulsated time series, For each message in the input stream, the sentiment time series contains a pair whose time is the time when the message was posted, and whose value is the result of the NLP processor. This value is called sentiment.

The frequency time series s_{f} depends on two parameters; the sentiment time series and a positive number w representing a time called window size. It is a pulsated time series. For each point (t, s) in the sentiment series, the frequency series contains a point (t, f) where f is the number of points in the sentiment series in the time range [t-w, t], divided by w. This number f is called frequency.

Formally,

$$f ( t ) = \frac{\# ( {s}_{s} ⋂ [ t - w , t ] )}{w}$$

$${s}_{f} = \{ ( t , f ( t ) ) \vert t ∈ {V}_{1} ( {s}_{s} ) \}$$

A pattern P is defined as a cross-correlation c in [−1,1], a positive window size w, a time lag l, and a time tₛ. These numbers are interpreted as “the predictive series over [tₛ−w, tₛ] correlates to the target series over [tₛ−w+1, tₛ+1] with a cross-correlation of c”.

Formally, a pattern is thus an element of [−1,1]× [symbol] × [symbol] ×

[symbol]

If the lag is positive, it is said to be predictive. The cross-correlation determines the relevance of the pattern: the higher it is, the more relevant the pattern is considered.

### 4.7 Pattern Identification Method

As explained in the '104 publication, the method is called the sentiment-frequency method. It uses the sentiment to create a sentiment-frequency series, and correlates the latter to the target using a plain statistical cross-correlation. It then identifies patterns by finding the optimal time lag.

Correlating two time-series using a plain statistical cross-correlation and finding the optimal lag is an independent component. This component is called the series correlator and is described below.

### 4.8Sentiment-Frequency Method

As explained in the '104 publication, the system first creates an average sentiment series s_{α} such that for every point (t,s) in the sentiment time series sₛ there is a point (t, a) in the average sentiment series where a is the arithmetic average of all the sentiments in the time range, or interval [t−W, t].

Formally let,

$${A}_{w} \text{:} t ∈ ℝ ↦ \frac{{\sum }_{( t , s ) ∈ {s}_{s} ⋂ [ t - w , t ]} s}{\# ( {s}_{s} ⋂ [ t = w , t ] )}$$

$${s}_{a} = \{ ( t , {A}_{w} ( t ) ) \vert t ∈ {V}_{1} ( {s}_{s} ⋂ [ t - w , t ] ) \}$$

The system then creates the sentiment-frequency series s_{sƒ} to contain a point (t, v_{sƒ}) for every (t,a) in the sentiment series and (t,f) in the frequency time series s_{ƒ}, where v_{sƒ}=ƒ^{α}(=e^{αln(ƒ)}).

Formally define as:

s_{sƒ}={(t, ƒ^{α})|(t, α)∈s_{α}, (t, ƒ)∈s_{ƒ}}

Next, the series correlator is applied to the sentiment-frequency series and the target.

### 4.9 Series Correlator

As explained in the '104 publication, the series correlator produces a set of patterns based on a real-valued pulsated time series sₚ, a real-valued sampled time series sₛ, an interpolation method I for sₛ, and a window size w.

The interpolation method I, is a function of a time series sₛ and of a time t that is C¹-piecewise continuous with respect to t, and such that if there exists a point (t,v) in sₛ, I(sₛ, t)=v. Interpolation is a classical subject and it will not be described here. Common interpolation methods are linear or cubic splines.

Formally,

I∈Tₛ→C¹( [symbol] → [symbol] )

∀(t,v)∈sₛ,I(sₛ,t)=v

For any time t and lag l, we defined the vector Eₛ(sₛ, sₚ, t, l) so that for every (tₚ,p) in sₚ with tₚ in [t−w,t], Eₛ(sₛ,sₚ,t,l) contains the point I(sₛ, tₚ+l). We call Eₛ(sₛ,sₚ,t,l) the interpolated.

Formally,

Eₛ(sₛ,sₚ,t,l)=1 (sₛ, V₁(sₚ∩[t−w,t])ᵢ+l)

The system also defines the vector Eₚ(sₚ,t) so that for every (tₚ,p) in sₚ with tₚ in [t−w,t], Eₚ(sₚ,t) contains the point p.

Formally,

Eₚ=V₂(sₚ∩[t−w,t])

The cross-correlation CC(sₛ, sₚ, t, l) is defined as the scalar product of Eₚ(sₚ,t) and Eₛ(sₛ,sₚ, t, l) divided by the product of their norms.

Formally,

$$\frac{〈 {E}_{p} ( {s}_{p} , t ) \vert {E}_{s} ( {s}_{s} , {s}_{p} , t , l ) 〉}{‖ {E}_{p} ( {s}_{p} , t ) ‖ ‖ {E}_{s} ( {s}_{s} , {s}_{p} , t , l ) ‖}$$

Since t [symbol] I(sₛ,t) is C¹-piecewise continuous, for any fixed t, CC(sₛ, sₚ, t, l) has a finite set of local maximums. There are many methods to find local maximums. One possible method is to use a gradient method on points spread evenly on the rime interval that the series covers.

From the definition above, the local maximums of CCₜ: l∈ [symbol] [symbol] CC(sₛ,sₚ,t,l) simply move linearly with t when no points of sₚ leaves or enters [t−w,t]. Hence the sets of local maximums of CCₜ for t or (t−w) the time of a point in sₚ is a finite set that represents completely the set of local maximums of CCₜ for all t.

For every w, the system computes a finite set of times t and lags l and a cross-correlation c for each of them. This defines a finite set of patterns (c, w, t, l) which the system orders by relevance.

### 4.10 Real-Time Target Prediction

As explained in the '104 publication, the system runs the previous algorithm for t=now. The system then chooses the one with the most relevant predictive lag, and project that the target will behave like the sentiment-frequency curve.

When applied to real-time several optimizations are made:
Non-predictive lags can be ignored (we don't have data on the target in the future),
The system only computes new local maximums when a new point arrives in the sentiment series.
Updating the cross-correlation series can be optimized, not all the scalar products have to be recomputed.
The system can reuse the local maximums we had already identified to find the new ones.

### 5. The Topic Calculator

The topic calculus applies to the output of the Cass tree produced by the partial parser 38 as discussed above with regard to the sentiment calculus. It compositionally derives the topic of short social media messages by computing a topic value for given entities in the event denoted by the social media message. The topic logic derives a topic value, ranging from 1 to 3, for prominent R expressions in short social media messages based upon a compositional calculus.

In the specific domain of stock-market exchanges, the topic calculus identifies topic values of a stock-entity with respect to the events described by the incoming short social media messages. Thereby, it calculates the topic of stock events with respect to the domain of interpretation of the keywords used to ingest the short social media messages.

The topic calculus is based on the properties of lexical items and phrases defined in the Stock-Lex 26, Pol-Lex 28, City-Lex 30 and Sent-Lex 32, and how they are syntactically organized in the Cass tree. The maximal local domain for the application of the topic calculus is the sentence. The partial parser, in the form of a Cass parser, derives syntactic domains, including propositional (c-domain), as well as more inclusive domains, such as the nominal (nx-domain) and the verbal (vx-domain). The topic rules apply to the asymmetrical head-complement, the modifier-modified relation and the subject-predicate relations in the parse trees generated by the Cass parser.

The topic of a sentence is an R-expression that restricts the information structure of the event described by that sentence. Moreover, the topicality of R-expressions can be detected on the basis of different factors, as discussed above. Taken together, these factors may provide an indication of the strength value of the topicality of R-expressions.

Another innovative dimension of the topic calculus includes separate topic rules for calculating the Restrictor of the information structure (R) and the Strength (S) of the Restrictor. The topic rules have the generic form of dyadic operators (Op (arg1, arg2)). Their specific form is dependent on the syntax-semantic relation between arg1 and arg2. The topic scope of a referential expression is the sum of the values of R and S for that expression.

### 5.1 Topic Rules

### 5.1.1 Restrictor (R) Rules

R ([x] [y]): assign an R-value to y, as specified by the following rules:
1. If x is a head and y is its complement, then
   i. if the subject is an R-expression, then [symbol] y=R.
   ii. if the subject is not an R-expression, then y=R.
2.If x is a constituent and y is its modifier, then [symbol] y=R.
3.If x is a predicate and y is its subject,
   i. if the subject is an R-expression, then y=R.
   ii. if the subject is not an R-expression, then [symbol] y=R.

### 5.1.2 Strength (S) rules

S ([x] [y]): Assign an S-value to y, as specified by the following rules:
1. If y is a R, and x is a head or a predicate, then S (y=1).
2. If y is a R and x is a pronoun, and x and y are part of a pronominal anaphoric chain, then add 1 to S (y).
3. If y is a R and
   i. y is a NE then add 1 to S (y)
   ii. y is not a NE, then include R in NE.

Thus, a topic of a short social media message is associated with a strength value 1 to 3, where 1 is the lowest strength and 3 is the highest strength. The strength of the topic indicates salience in the set of topics extracted for given keywords. The topic calculator identifies the restrictor and the strength values of an R-expression. The restrictor and the strength are computed according to Topic rules provided above,

### 5.2 The Sentiment/Topic Inference Engine

As explained above, the sentiment/topic inference engine 40 is part of the architecture of the system 10 and provides a means to sharpen the accuracy of the results by bringing world knowledge into the computation.

The sentiment/topic inference engine 40 is composed of a knowledge base and a set of inference rules. The knowledge base includes name entities, which are recognized early in the computation and used in the topic calculus. As specified above, the topicality of R-expressions is not only dependent on the syntax-semantic prominence of R-expressions, but also on their relatedness to name entities in the knowledge base of the keywords used to ingest the social media messages.

A topic is relative to the domain of interpretation of keywords used to ingest the social media messages. This domain is constituted of events with pre--specified entities, such as assets in the stock-exchange domain, political actors, such as candidates in a presidential campaign in the political domain, and names of cities, museums and expos in the city domain. These name entities participate in events, such as the World Expo 2020 in Dubai or the 2016 campaign for US presidency or intraday trading. The topic calculator 20 performs event-driven topic calculus.

The present method and system takes an event to be a change in the relation between the participants of that event in domain of interpretation, such as the financial domain, the political domain or the city domain. The participants of an event are: names, organizations, locations, expressions of time, quantities, monetary values, percentages, etc. The topic detection system must include name entity recognition capacities in addition to syntax-semantic parsing capacities, as the syntax-semantic structure of sentences provides the articulation of events and their participants.

The domain dependent event-driven approach to topic detection can be represented in (49), where D stands for Domain of interpretation, M stands for the aspectual Modifier of the event, Ev stands for Event, and x, . . . , z stand for the participants of the event. A topic is a participant of the event structure in a domain of interpretation.
(49) (D (M (Ev(x, . . . , z))))

This relational approach to topic detection contrasts with the statistical and machine learning approaches, classifying social media messages on the basis of feature words. Such methods fail to identify the topics of social media messages relative to the world of interpretation of the keywords used to ingest them.

In the domain of stock exchange, topic detection is relative to stock events. The topic calculator 20 derives the topics of short social media messages, such as social media messages, including stock entities (Assets, referenced by tickers and commodity names for example) as they participate in ongoing stock events described by the ingested social media messages. The generic representation in (49) can thus be instantiated by (50) for stock events, and (51) for political events and (52) of city events.
(50) (D (M (Stock-event (Stock-entity x , . . . , Stock-entity z))))
(51) (D (M (Political-event (Pol-entity x , . . . , Pol-entity z))))
(52) (D (M (City-event (City-entity x, . . . , City-entity z ))))

The knowledge base of stock exchange events 42 consists of data structures relating stock entities (tickers, company names, products, etc.), stock events (e.g., upgrade, downgrade) and facts, extracted from news wire as well as other sources. The knowledge base includes the asset tree, and the competition map, as illustrated in FIG. 8. The root of the stock asset tree is a variable that can be replaced by any ticker symbol name, for example AAPL, in which case the immediate sister nodes, would be Apple, Apple Inc., Apple Corp., Apple corporation, etc., and Apple products, such as iPhone, iPad, iWatch, etc. The competition map contains parallel information for competitive stocks such as GOOG (Google) or MSFT (Microsoft), and allies, such as Cisco and IBM, as illustrated in FIG. 9.

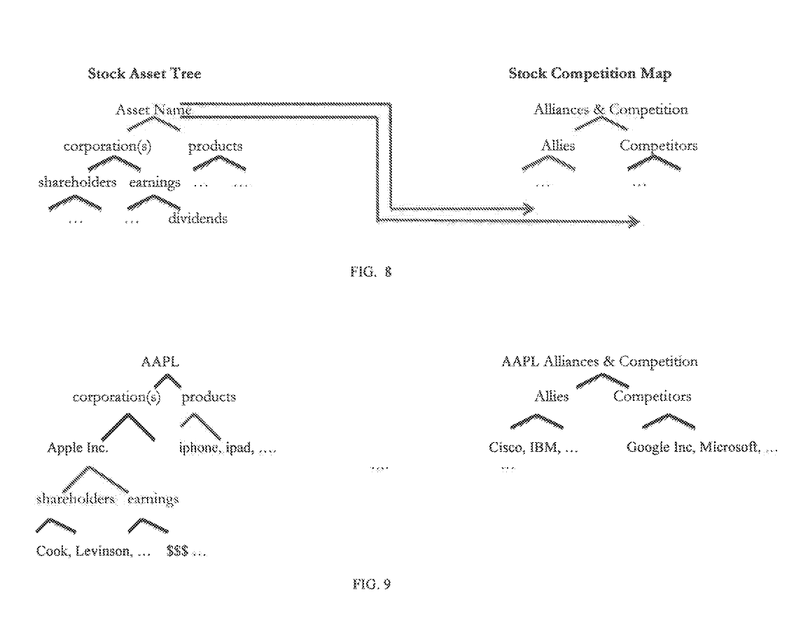

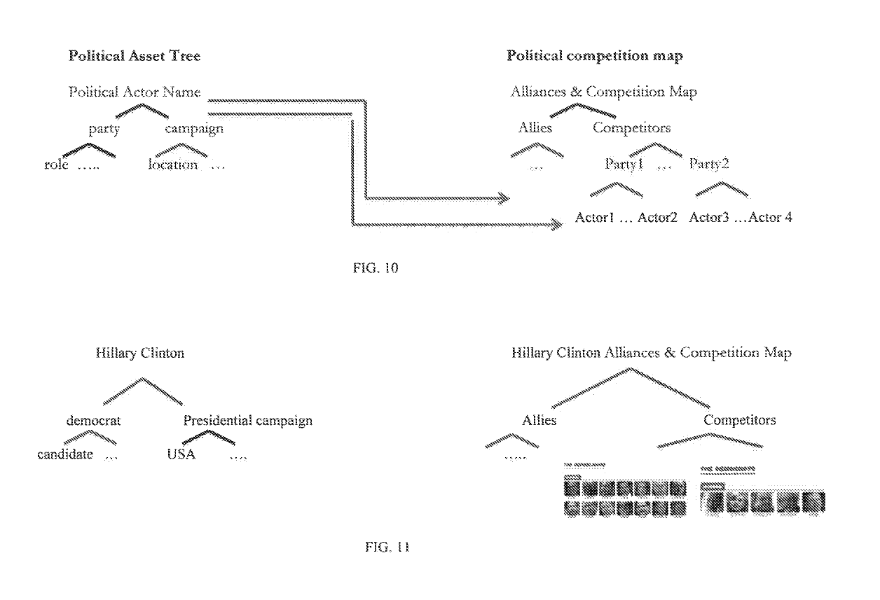

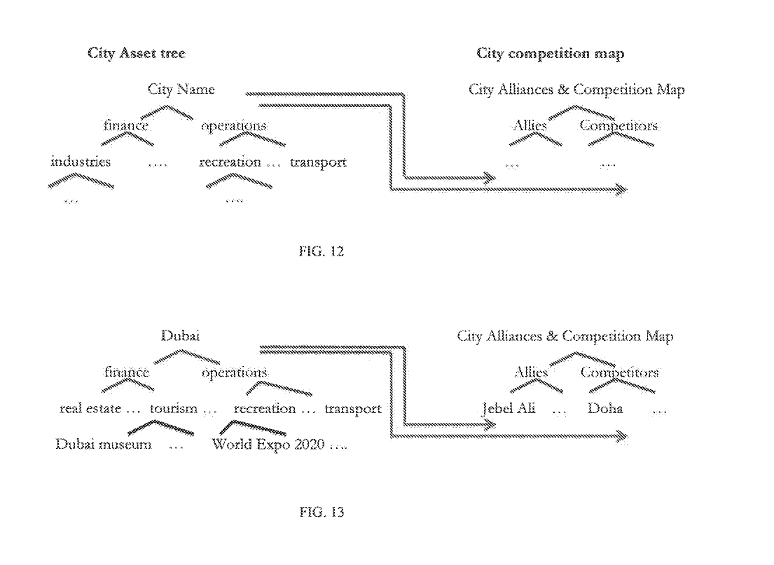

The knowledge base relating to political events 44 consists of data structures relating political entities (e.g. president, candidate, campaign, parties) and political events (e.g. vote, elect). The knowledge base includes Political Asset tree for political actors, and the competition map, as illustrated in FIG. 10. FIG. 11 shows a political asset tree for Hillary Clinton and a political competition map between the candidates for two political parties in the 2016 United States presidential campaign. The knowledge base relating to city events 46 consists of data structures relating city entities (e.g. museums, hotels, stadiums, restaurants) and city events (e.g. Expos, Olympics). The city knowledge base 46 includes city asset tree, and a competition map, as illustrated in FIG. 12, as more than one city may compete to be the location of events such as world's fare or Olympics, and more than one city can allies with respect to a given event. This is illustrated in FIG. 13 for Dubai and Doha for the World Expo 2020.

Such a detailed knowledge base is necessary to the accurate computation of topic values, as well as sentiment values for keywords in short social media messages. The keywords used to ingest the social media messages can be ticker symbols, but also company names or products, and their topicality can be relativized to different ingested keywords. The competition map is necessary to ensure that the topic and sentiment values are assigned to the specific ticker symbols in social media messages including a trailing of ticker symbols, which are often related to different competing companies. Where the focus is upon political sentiment, the keywords used to ingest the social media messages are the names of the political actors, as well as keywords related to political dimensions, such as image, economy, demographic groups, residential battleground states, and attack corridors.

The sentiment/topic inference engine 40 also includes a set of inference rules for general reasoning and its specific instantiations in specific domains of interpretation. The innovative character or the system also lies in the fact that it includes inference rules that interact with the topic calculus of the topic calculator 20 ensuring the knowledge base of the tickers is dynamically incremented by the inclusion of syntactically prominent R-expressions that are not name entities in the keywords' knowledge base.

The sentiment/topic inference engine 40 ensures that the topic calculus is grounded in specific domains of interpretation. It contributes to the innovative technology, which leads to both simplify and sharpen decision making in stock market transactions and political issues in real time.

The present system 10 and method relies on the recovery of natural language asymmetrical relations in order to identify topics in linguistic expressions, The precedence, dominance and asymmetrical constituent-command (hereafter c-command) relations, defined in (53e), are the central asymmetrical relations. Thus, in (53a), X precedes Z, and Z does not precede X. In (53b), Z and Y are dominated by X, and not conversely. In (53c), X asymmetrically c-commands Y, and not conversely. These structure dependent relations are used in the topic calculus.

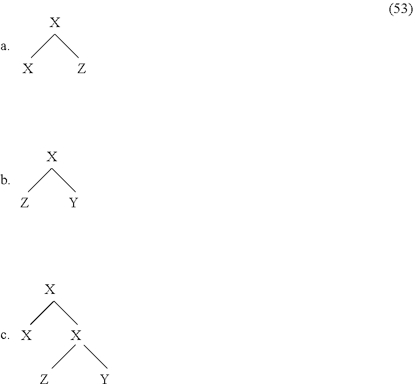

d. C-command; X c-commands Y iff X and Y are categories and X excludes Y, and every category that dominates X dominates Y.

e. Asymmetric c-command: X asymmetrically c-commands Y, iff X c-commands Y and Y does not c-command X.

The system 10 identifies topics in specific syntax-semantic configurations. R-expressions occupying deep subject and object positions qualify as topics. Thus, nominal constituents that do not have independent reference, such as pronouns and quantifiers, do not qualify as topics. The simplified structures in (54) illustrate that the topic, here the iPhone6, is an R-expressions that occupies a prominent position in the sense that its maximal projection asymmetrically c-commands the others R-expressions in these structures. In (55), Hillary is the topic as it is the R-expression that occupies the most prominent position, defined in terms of the asymmetrical c-command relation.

The topicality of R-expressions is dependent on their syntax-semantic prominence as well as on whether or not they are identified as name entities in the knowledge base of the keyword used to ingest the social media messages and on whether or not they are part of anaphoric chains. The conditions are part of the innovative topic calculus rules. As discussed above, the topic calculus consists of two sets of rules: restrictor rules and strength rules. The first set of rules, the R-rules, assigns a numeric value to prominent R-expressions compositionally in their syntax-semantic parse trees. The second set of rules, the S-rules, assigns a numeric value to these R-expressions according to whether or not they are part of anaphoric chains in short social media message including more than one sentence, and whether or not they include name entities that are part of the knowledge base of the keywords used to ingest the social media messages. The numerical values are composed and associated to the prominent R-expressions identified as being the topics of short social media messages relative to the pre-selected keywords. The values can be used to rank the topics of sets of social media messages selected with the same set of keywords.

Operative topic detection systems are generally based on statistical machine learning methods as well as partial NLP methods. Such methods, including bag-of-words methods and Part-of-Speech methods provide noisy results for processing short social media messages in real time. The present topic calculator provides a solution to the core problem associated with current practice in topic detection, namely its poor performance. It does so by relying on the universal syntax-semantic asymmetries of natural language expressions as well as their anchoring in world knowledge.

The following paragraphs identify specific problems with real-time topic detection in short social media messages generated by social media, which are confronted in accordance with the implementation of the present system and method.
The first set of problems is dependent on the fact that social media messages are generally extracted from their dialog context in which topics can be detected on the basis of a larger information space. Thus, the domain of interpretation of these social media messages is not directly accessible. The present system overcomes these problems by relying on the syntax-semantic structure of the sentences and on the detection of name entities in the social media messages,
A second set of problems in dependent of the fact that the social media messages are short. For example, a social media message is limited to 140 characters. Because of this limitation, they lack several constituents that are normally part of English sentences. More often than not, they are truncated messages. Furthermore, they include characters and expressions that are not part of English. The present system overcomes these problems by integrating topic detection in a system that pre-processes short and noisy messages ingested from social media and recovers their syntax-semantic structure. This structure is the input to information processing modules, including sentiment calculus and, with the proposed invention, topic calculus.
The present system solves the problems related to the online detection of topics of social media messages efficiently and in real-time. The invention identifies topics by a set of deterministic rules that apply to the underlying syntax-semantic structure of pre-processed messages. Once a prominent R-expression is detected the topic value of 1 is assigned to that expression. Furthermore, pronominal anaphora is used to strengthen the topicality of R-expressions in short social media messages including several sentences, as it does in a discourse or a conversation. In such cases, the topic value of that R-expression is increased by 1. In addition to syntax-semantic properties, world knowledge information strengthens topicality of R-expressions. Topics describe familiar information. Name entities stored in the knowledge base of keywords are also familiar information. Name entities are detected very early in the pipeline depicted in FIG. 1. This information is available at the syntax-semantic level. When a syntactically prominent R-expression is also a name entity its topic value is increased by 1.
The innovative character of the system also lies in the fact that the knowledge base of the tickers is dynamically incremented by the inclusion of syntactically prominent R-expressions that are not Name Entities in the keywords' knowledge base.

### 5.3 Technical Advantages

The overall advantage of the present system is that it identifies topics on the basis of the recovery of natural language relations rather than on statistical and Machine Learning techniques. Contrary to the latter methods, the topic calculator does not eliminate the syntax-semantic relations between the parts of the social media messages, but uses these relations to process the content of the social media messages. This is not the case of other known technologies. Because it preserves the information structure of the social media messages in the computation, the topic calculator ensures more efficient topic detection than statistical-based systems.

A first technical advantage of the development is that it uses a rule-based method. Thus, it avoids the shortcomings of the purely statistical as well as those of the POS analysis used in current practice in topic detection, as detailed below. A second technical advantage of the topic calculator is that it processes the social media messages directly instead of classifying social media messages on the basis of probabilistic algorithms. A third advantage of the proposed system is that it relies on knowledge based name entities for topic identification. An overall technical advantage of the development is that the topic calculus is integrated in an efficient and operative system for the sentiment processing of short and noisy messages generated by social media in real time (see the '104 publication).

The present system solves the problems associated with the online detection of topics in incoming short social media messages by processing the content of these social media messages without eliminating the syntax-semantic asymmetries underlying information structure. The system does not extract sets of words or n-grams from short social media messages and calculate their frequencies, and does not use classification algorithms, such as Naïve Bayes classifiers, contrary to common practice. It relies on deep syntax-semantic processing and not only on part of speech. Furthermore, it relies on a knowledge base including name entities and event types, which are dynamically updated by the present invention itself. The features of the system that provide a solution or benefit to solve the problem are the following:
i) the ingestion of short messages on the basis of targeted keywords;
ii) the filtering of units that are not part of natural language (English);
iii) the tagging of the items in the filtered messages with part-of-speech tags;
iv) the lemmatization of their lexical items;
v) the recovery of the syntactic-semantic structure of each message;
vi) the identification of R-expressions in the syntax-semantic structure;
vii) the identification of syntax-semantic prominent R-expressions;
viii) the detection of name entities in the syntax-semantic structure; and
ix) the application of the topic calculus rules to the output of the syntax-semantic structure.

The topic calculator identifies topics configurationally on the basis of the syntax-semantic prominence of R-expressions and the knowledge base information on the keywords used to ingest the social media messages.

### 6. Summary

The topic calculator of the present invention is embedded in a system that ingests social media social media messages from multiple social media sources based on user-specified criteria, represented by keywords. The ingested social media messages go through a filtering layer, purging the social media messages from noise (URLs, hashtags, etc.). The tokens of the filtered social media messages are assigned part of speech tags according to the lexical and contextual properties of the lexical items. A shallow parser then recovers the major constituents of the tokenized social media messages. The topic calculator takes the parse tree of an ingested short social media message as its input and yields a topic values for designated R-expressions compositionally on the basis of the syntax-semantic properties of the parse tree and the knowledge base of the keywords used to ingest the social media messages.

Given its universal properties, the system can be parameterized to apply to other languages than English, to other information processing applications than sentiment, event and topic detection, as well as to other domains of interpretation than finance, including politics, cities, health and security.

### 7. Sample of Traces Including the Output of the Topic Calculator

The application of the topic rules to short social media messages ingested with the keyword $AAPL is illustrated with, the following three examples. In the parse trees below, the topic calculus assigns a topic value to designated R-expressions, whereas the sentiment calculus assign sentiment values to the social media messages. In both cases the values are relative to the keywords used to ingest them.

The first example in (57) includes an R-expression, shares, but no recognized name entity or pronominal anaphora.

### (57) $AAPL, I will buy shares today.

The trace in (58) for (57) shows the application of the Restrictor rule 1ii to the R-expression shares. This R-expression occupies the complement position of the verb buy, whose subject is a pronoun. Consequently, the valise R is assigned to that R-expression. Furthermore the Strength rule (1) is applied to this configuration and assigns the S value of 1 to the R-expressions shares. The results of these two rules is R{1} for that R-expression. No other topic calculus rule applies in the computation since the social media message contains no other R-expression. As a result the topic value of 1 is computed for the R-expression shares with respect to the keyword $aapl: TOP {1} (shares).

```
(58)  root/SUBJ[ne.aapl/$aapl cma/, prp/I,KW($aapl)] Sc{n0} PRED
[md-fu/will
  vb/buy,L{+3},Sc{+5} nn/appl,Sc{n2} nns/shares,L{n2},Sc{n2}, R{1}
  day-pr/today per/.] Sc{+5} i=0
    nx/ i=0
      ne.aapl/[$aapl] KW[$aapl] NE:aapl i=1
    cma/[,] i=2
    c/ i=3
      c0/ i=4
        nx/ i=5
          prp /[I] i=6
        vx/ i=7
          md-fu/[will] i=8
        vb/[buy,L{+3},Sc{+3} HEAD[VERBAL:vb/buy,L{+3},Sc{+5}-
>nns/shares,L{n2},Sc{n2}, R{1}] Sc{+5} rule;=[nx:6 /+/ and n = +:
‘to upgrade a stock’] i=9
      nx/ i=10
        nn_cpd/ i=11
  nn/[appl,Sc{n2} R{1}] i=12
        nns/[shares,L,{n2},Sc{n2} R{1}] i=13
    day-pr/[today] i=14
  per/[.] i=15
-----Matched keywords -----
$aapl
----- Sentence Results ------
SEN[$aapl , I will buy appl shares today .] S{+5} NS{+83.33} NwS[2]
KW[$aapl]
SnP+[Sc{n0},Sc{+5}]
----- SentiAttr -----
  SA[$aapl S{+5} NS{+83.33} TOP {1} (shares)]
```

This trace shows that the recovery of the underlying syntax-semantic structure of the social media messages provides the basis for the application of the Topic calculus and the sentiment calculus. Both calculi apply in local syntactic domains and identify the topic (restrictor and strength) and the sentiment (polarity and strength) of short social media messages with respect to designated keywords.

The trace in (60), for the example in (59), shows that the topic calculator yields the TOP value of {2} for the R-expression AAPL shares. This expression is the most prominent R-expression of the syntax-semantic structure. Thus it is assigned the value R by the restrictor rule 1b and the value of 1 by the Strength rule 1. Furthermore it is assigned an additional Strength value of 1 because it contains the Name Entity (NE) aapl. As a result the topic value of 2 is computed for the R-expression aapl shares with respect to the keyword $aapl: TOP {2} (aapl shares).

```
(59)  $AAPL. Its AAPL shares that I bought today.
(60)  root/SUBJ[ne.aapl/$aapl cma/, prps/Its ne.aapl/aapl,Sc{n2}
nns/shares,L{n2},Sc{n2} comp/that prp/I,KW($aapl)] Sc{n2} R{2}
PRED[vbd/bought,L{+3},Sc{+3} day-pr/today per/.] Sc {+3} i=0
  nx/ i=0
    ne.aapl/[$aapl] KW[$aapl] NE:aapl i=1
  cma/[,] i=2
  nx/ i=3
    prps/[Its] i=4
    nn_cpd/ i=5
      ne.aapl/[aapl,Sc{n2}] KW[$aapl] NE:aapl R{1}] i=6
      nns/[shares,L{n2},Sc{n2}, R{1}] i=7
  subc/ i=8
    subc0/ i=9
      comp/[that] i=10
      nx/ i=11
        prp/[I] i=12
      vx/ i=13
        vbd/[bought,L{+3},Sc{+3},EV.M&A(bought)] i=14
    day-pr/[today] i=15
  per/[.] i=16
----- Matched keywords -----
$aapl
----- Sentence Results -----
SEN[$aapl , Its aapl shares that I bought today .] S{+5} NS{+83.33)
NwS[2] KW[$appl]
SnP+[Sc{n2},Sc{+3}]
----- SentiAttr -----
SA[$aapl S{+5} NS{+83.33}] R{2} (aapl shares)]
```

Short social media messages may include more than one sentence, may talk about more than one asset, more than one stock event, and they may include more than one topic. Computing blindly the topic values of all the referential expression in the social media messages, the resulting value is general and not necessarily asset specific. The topic calculator is sentence bound. It applies iteratively in the local domain of the ASSET (keyword, set of keywords), e.g. $AAPL $SPY, and the expression of a stock event (e.g., loose, gain, sell, buy). Moreover, it is sensitive to the fact that pronominal anaphora strengthens the topicality of R-expressions.

The trace in (62), for the example in (61), shows that the topic calculator yields the TOP value of {3} to the R-expression AAPL, shares: TOP{3} (apple shares). This R-expression includes the NE aapl and occupies the most prominent position in the first sentence. Furthermore it is the antecedent of the pronoun them located in the second sentence.

```
(61)  RT @collifornia: Dont buy AAPL shares anymore. MSFT basically rendered them
useless. $AAPL
(62)  root/ i=0
    vp/SUBJ[_dummy_/subject] Sc{0} PRED[do/do rbneg/not vb/buy,L{+3},Sc{−5}
  ne.aapl/aapl,Sc{n2} nns/shares,L{n2},Sc{n2}, R{3} rb/anymore per/.,KW($aapl)]
  Sc{−5} i=0
      vx/ MOD[VERB_TAIL_ADVERB:rb/anymore->vb/buy,L{+3},Sc{−5} NEG]
  Scn{−3} rule=[24 /n/ and + = +: ‘an average upgrade’] i=1
        do/[do] i=2
        rbneg/[not] i=3
        vb/[buy,L{+3},Sc{+3},NOT EV.M&A(buy)]
  HEAD[VERBAL:vb/buy,L{+3},Sc{−5}->nns/shares,L{n2},Sc{n2}] Sc{−5}rule=[nx:8
  /−/ and n =−: ‘to miss estimates’] i=4
      nx/ i=5
        nn_cpd/ i=6
          ne.aapl/[aapl,Sc{n2}] KW[$aapl] NE:aapl R{1}] i=7
          nns/shares,L{n2},Sc{n2}, R{1}] i=8
      rb/[anymore] i=9
    per/[.] i=10
    c/ i=11
      c0/SUBJ[prp/They] Sc{n0} PRED[rb/basicaly,L{n1},Sc{n1}
  vbd/rendered,Sc{n1} prp/them jjex/useless,L{−2},Sc{−2} per/.] Sc{−3} i=12
        nx/ i=13
          prp/[They] i=14
        vx/ MOD[VERB_PREV_SIB:rb/basically,L{n1},Sc{n1}-
  >vbd/rendered,Sc{n1}] Sc{n1} rule=[30 /n/ and n = n: ‘an average result’] i=15
          rb/[basically,L{n1},Sc{n1}] i=16
        vbd/[rendered] HEAD[VERBAL:vbd/rendered,Sc{n1}->prp/them] Sc{n1}
rule=[nx:14 /n/ and n = n: ‘to report the results’] i=17
      nx/ i=18
          prp/[them] i=19 R{1}]
    ax/ i=20
      jjex/[useless,L,{−2},Sc{−2}] i=21
  per/[.] i=22
  nx/ i=23
    ne.aapl/[$aapl] KW[$aapl] NE:aapl i=24
------ Matched keywords -------
$aapl
-------- Sentence Results -----
SEN[do not buy appl shares anymore .] S{−5} NS{−83.33} NwS[2] KW[$appl] SnP-
[Sc{n0},Sc{−5}] OR{se[buy:simple]}
SEN[They basically rendered them useless .] S{−3} NS{−33.33} NwS[3] SnP-
[Sc{n0)},Sc{−3}]
SEN[$aapl] S{n0} NS{n0} NwS[0] KW[$appl]
----- SentiAttr -----
SA[$aapl S{−5} NS{−55.56} Top{3} (apple shares)]
```

The traces above illustrate the application of the topic calculus. The Topic value of R-expressions is computed on the basis of their syntax-semantic prominence as well as with respect to whether or not they include a NE and finally with respect to whether or not they are the antecedent of pronouns in anaphoric chains.

While the preferred embodiments have been shown and described, it will be understood that there is no intent to limit the invention by such disclosure, but rather, is intended to cover all modifications and alternate constructions falling within the spirit and scope of the invention.

1. A computer-implemented system for real time topic detection in a social media message, wherein information structure of the social media message includes a topic and a comment, and wherein the topic is an R-expression (Referential expression) that restricts the information structure of an event described by the social media message, comprising:
a knowledge base of keywords used to ingest the social media message;
a partial parser deriving a syntax-semantic parse tree;
a topic calculator compositionally deriving the topic of the social media message by computing a topic value for given entities in the event described by the social media message, wherein the topic value is derived from a first set of rules assigning a Restrictor R-value to prominent R-expressions compositionally in the syntax-semantic parse tree and a second set of rules assigning a numeric Strength S-value to the R-expressions according to whether or not they are part of anaphoric chains in the social media message, and whether or not the R-expressions include name entities that are part of the knowledge base of keywords.

2. The computer-implemented system for real time topic detection in the social media message according to claim 1, further including an inference engine reducing uncertainty in results of the topic calculator.

3. The computer-implemented system for real time topic detection in the social media message according to claim 2, wherein the inference engine includes a data structure and a set of inference rules.

4. The computer-implemented system for real time topic detection in the social media message according to claim 1, wherein the topic value of the social media message is associated with a strength value 1 to 3, where 1 is the lowest strength and 3 is the highest strength.

5. The computer-implemented system for real time topic detection in the social media message according to claim 4, wherein the strength value is the sum of the numeric Strength S-value of the second set of rates.
